(19) United States
(12) Patent Application Publication
(10) Pub. No.: US 2026/0228596 A1
(43) Pub. Date: Aug. 6, 2026

(54) METHOD FOR IMPLEMENTING A QUANTUM MEASUREMENT

(71) Applicant: Algorithmiq Oy, Helsinki (FI)

(72) Inventor: Adam Glos, Zory (PL)

(21) Appl. No.: 19/153,136

(22) PCT Filed: Feb. 5, 2024
(86) PCT No.: PCT/EP2024/052748

§ 371 Date: Aug. 1, 2025

(30) Foreign Application Priority Data
Feb. 8, 2023 (EP) 23155538.4

(51) Int. Cl. G06N 10/70

(52) U.S. Cl. CPC G06N 10/70

(57) ABSTRACT

The present invention is related to a method for implementing a quantum measurement on a system quantum state of a composite system of a quantum computing device, said composite system comprising a plurality of quantum mechanical subsystems Qₙ, n=1 N, N≥2, said quantum mechanical subsystems being preferably qubits, and said quantum computing device having a connectivity and operativity that allows to implement for each of said subsystems Qₙ a potentially imperfect realization of a joint unitary operation (I) and a joint quantum measurement on a joint system of said subsystem Qₙ and at least one connected subsystem (II), of said plurality of subsystems, said realization of said joint quantum measurement being described by a plurality of measurement operators (III) each measurement operator (III) being associated with a measurement outcome (IV). The present invention is further related to an apparatus for carrying out said method.

### CROSS REFERENCE TO RELATED APPLICATIONS

The present application is a national stage application of International Application No. PCT/EP2024/0052748, filed Feb. 5, 2024, entitled “METHOD FOR IMPLEMENTING A QUANTUM MEASUREMENT,” which claims priority to European Application No. 2315538.4, filed on Feb. 8, 2023, the entirety of each of which is incorporated herein by reference.

### TECHNICAL FIELD

The present invention is related to a method for implementing a quantum measurement on a system quantum state of a composite system of a quantum computing device, said composite system comprising a plurality of quantum mechanical subsystems Qₙ, n=1, . . . , N, N>2, said quantum mechanical subsystems being preferably qubits, and said quantum computing device having a connectivity and operativity that allows to implement for each of said subsystems Qₙ a potentially imperfect realization of a joint unitary operation Uₙₙ_{_{c}} and a joint quantum measurement on a joint system of said subsystem Qₙ and at least one connected subsystem Qₙ, of said plurality of subsystems, said realization of said joint quantum measurement being described by a plurality of measurement operators

$${M}_{{m}_{n , {n}_{c}}}^{( n , {n}_{c} )} ,$$

each measurement operator

$${M}_{{m}_{n , {n}_{c}}}^{( n , {n}_{c} )}$$

being associated with a measurement outcome m_{n,n}_{_{c}}. The present invention is further related to an apparatus for carrying out said method.

### BACKGROUND

Quantum computing devices potentially enable to perform computations that are intractable on a classical computing device. To this end, the quantum computing device comprises a composite system of a plurality of quantum mechanical subsystems, for example, qubits, which serve as carriers of information and which may be manipulated according to the laws of quantum mechanics. For example, the composite system may be prepared in a pre-determined initial state and the quantum computing device may be operative to perform a unitary transformation on said initial state, for example, by quantum gate application, to thereby create a system quantum state which encodes the solution of a desired computational task. To read out the solution, a quantum measurement may be performed on the system quantum state.

Positive Operator Valued Measures (POVMs) describe the most general form of a quantum measurement. Of particular interest are informationally complete POVMs, as they can in principle be used to estimate any expectation value of our choice. Furthermore, the physical implementation of POVMs has a plurality of applications. For example, POVMs allow to distinguish probabilistically between non-orthogonal quantum states thereby enabling optimal state discrimination and efficient quantum tomography. In quantum communication and cryptography, POVMs are used to enable secure device-independent communication, or, on the contrary, to compromise quantum key distribution protocols.

Various protocols for implementing POVMs in physical systems are proposed in the literature, including sequential classically-controlled quantum operations (see, e. g., E. Andersson and D. K. L. Oi, Binary search trees for generalized measurement, Phys. Rev. A 77:052 104, May 2018, R. Iten, R. Colbeck and M. Christandl, Quantum Circuits for Quantum Channels, Phys. Rev. A 95:052 316, May 2017) and randomized quantum circuits (see, e. g., A. Acharya, S. Saha and A. M. Sengupta, Informationally complete POVM-based shadow tomography, arXiv:2105.05992, 2021). Other protocols rely on Naimark's dilation theorem. According to this theorem, any M-outcome POVM on a quantum system QS can be realized by introducing an ancilla system A with a Hilbert space of dimension M and spanned by M orthonormal basis states that are in one-to-one correspondence with the POVM measurement outcomes. Then, the M-outcome POVM may be realized by applying a global unitary operation to the joint system of the quantum system QS and the ancilla system A followed by a projective measurement on the basis states of the ancilla system A. Provided that the POVM measurement is realized using a quantum hardware with quantum particles that live in coherently controllable qudit spaces, Naimark's dilation theorem may also be applied within the qudit space (see L. E. Fischer, D. Miller, F. Tacchino, P. Kl. Barkoutsos, D. J. Egger and I. Tavernelli, Ancilla-free implementation of generalized measurements for qubits embedded in a qudit space, arXiv:2203.07369v1).

While Naimark's dilation theorem allows in principle for the realization of an arbitrary POVM, its implementation in a physical system may be very inefficient. For example, in case that a POVM measurement should be implemented on each qubit of a register of N qubits, e. g., as the read-out of a quantum computation, each of the qubits has to be coupled to one ancilla system comprising at least one qubit. This approach multiplies the number of necessary qubits during the measurement stage. When the qubits are realized on a quantum chip, e. g., as superconducting qubits, the number of qubits that may then be used for a computation is thus reduced by a potentially large factor. Moreover, the limited connectivity of most quantum architectures may lead to a significant SWAP-gate overhead.

### SUMMARY

Due to these problems in the prior art, it is therefore an object of the present invention to provide an efficient method for implementing a Positive Operator Valued Measure on a quantum state of a composite system of a quantum computing device which comprises at least two quantum mechanical subsystems Qₙ, n=1, . . . , N, and to provide an apparatus for carrying out said method.

According to a first aspect of the present invention, this object is attained by further developing the method for implementing a quantum measurement mentioned above in that the method comprises:
an initial measurement step which comprises for at least one initially selected subsystem Qₙ_{₀} a realization of an n₀-th local Positive Operator Valued Measure on said initially selected subsystem Qₙ_{₀} to thereby obtain a measurement outcome mₙ_{ₒ};
an iterative measurement step which comprises for at least one iteratively selected subsystem Qₙ a realization of an n-th local Positive Operator Valued Measure on said iteratively selected subsystem Qₙ by implementing, by operation of said quantum computing device, said potentially imperfect realization of said joint unitary operation U_{n,n}_{_{c}} followed by said joint quantum measurement described by said plurality of measurement operators

$${M}_{{m}_{n , {n}_{c}}}^{( n , {n}_{c} )}$$

on said joint system of said iteratively selected subsystem Qₙ and said at least one connected subsystem Qₙ_{_{c}}, wherein said at least one connected subsystem Qₙ_{_{c}} is in a previously determined quantum state described by a density operator ρₙ_{_{c}}, to thereby obtain a measurement outcome m_{n,n}_{_{c}},
wherein for at least one iteratively selected subsystem Qₙ at least one of said connected subsystems Qₙ_{_{c}}, and preferably each of said connected subsystems Qₙ_{_{c}}, is one of said at least one initially selected subsystems Qₙ_{ₒ}.

The quantum mechanical subsystems of said composite system are preferably qubits, i.e. quantum mechanical two-level systems. However, the invention is not limited to this, and the quantum mechanical subsystems may comprise qubits, qudits or any other quantum mechanical system in other embodiments. The plurality of N quantum mechanical subsystems comprises at least two quantum mechanical subsystems, i.e., N≥2.

The quantum computing device according to the above method has a special connectivity and operativity as has been explained above and may comprise means for implementing, for each subsystem Qₙ, the joint unitary operation on said joint system of said subsystem Qₙ and the least one connected subsystem Qₙ_{_{c}} of said plurality. The number of connected subsystems may be different for each subsystem Qₙ or it may be the same for all subsystems Qₙ. In one embodiment, there may be exactly one connected subsystem Qₙ_{_{c}} for at least one subsystem Qₙ. In the case, where the subsystem Qₙ and the one connected subsystem Qₙ_{_{c}} are qubits, the joint unitary operation Uₙₙ_{_{c}} is then a two-qubit unitary operation. In one embodiment, there is exactly one connected subsystem Qₙ_{_{c}} for each subsystem Qₙ. The quantum computing device may be a superconducting quantum computing device based on superconducting qubits, but it is not limited to this.

In one example, the connected subsystem(s) of pairs of subsystems Qₙ, Q_{ñ}, are different from each other. In another example, there are at least two subsystems Qₙ, Q_{ñ}, such that they have at least one connected subsystem in common.

For at least one subsystem Qₙ of said plurality, and preferably for all subsystems Qₙ, the joint unitary operation U_{n,n}_{_{c}} is a non-trivial unitary operation, that is, it is different from the identity operation.

In an ideal scenario, the physical realization of the joint unitary operation is perfect, i.e., the evolution of the joint system is a unitary evolution according to the joint unitary operation. However, in reality there may be errors in the implementation of U_{n,n}_{_{c}} due to noise or other imperfections so that the physical realization of the joint unitary operation is different from U_{n,n}_{_{c}}. For example, in reality a unitary operation which is different from the joint unitary operation U_{n,n}_{_{c}} may be implemented on the joint system. In other scenarios, the evolution may not even be a unitary evolution of the joint system, but a more general evolution described by a quantum channel E_{n,n}_{_{c}}. The quantum channel E_{n,n}_{_{c}} may, e.g., be determined experimentally via Quantum Process Tomography.

The quantum computing device may further comprise means for implementing, for each subsystem Qₙ, the joint quantum measurement on said joint system. For at least one subsystem Qₙ, and preferably for all subsystems Qₙ, the joint quantum measurement may be a non-trivial quantum measurement. That is, the measurement operators

$${M}_{{m}_{n , {n}_{c}}}^{( n , {n}_{c} )}$$

are non-trivial measurement operators, that is, they are different from the identity. The measurement operator

$${M}_{{m}_{n , {n}_{c}}}^{( n , {n}_{c} )}$$

has the associated measurement outcome mₙₙ_{_{c}}. The measurement operators fulfill

$${\sum }_{{m}_{n , {n}_{c}}} {M}_{{m}_{n , {n}_{c}}}^{( n , {n}_{c} ) †} {M}_{{m}_{n , {n}_{c}}}^{( n , {n}_{c} )} = 𝟙 ,$$

wherein [symbol] is the identity The joint quantum measurement may be any possible measurement. In general, at least one, and preferably, all joint quantum measurements are described by at least two measurement operators. The measurement operators may, e.g., be determined by Quantum Detector Tomography.

The initial measurement step comprises for at least one initially selected subsystem Qₙ_{ₒ} the realization of the n₀-th local Positive Operator Valued Measure on said initially selected subsystem Qₙ_{ₒ}. There is no limitation on how the POVM is realized in practice. For example, the n₀-th local POVM may be realized on the initially selected subsystem Qₙ_{ₒ} by implementing, by operation of said quantum computing device, said potentially imperfect realization of said joint unitary operation Uₙ_{ₒ}ₙ_{_{oc}} followed by said joint quantum measurement described by said plurality of measurement operators

$${M}_{{m}_{{n}_{o} , {n}_{o c}}}^{( {n}_{o ,} {n}_{o c} )} ,$$

on sala Initially selected subsystem Qₙ_{ₒ} and said at least one connected subsystem Qₙ_{ₒ} of said initially selected subsystem Qₙ_{ₒ}, wherein said at least one connected subsystem Qₙ_{_{oc}} is in a predetermined quantum state described by a density operator ρₙ_{_{oc}}, said predetermined quantum state being prepared by quantum state preparation. In one example, said predetermined quantum state may be the ground state of the quantum mechanical subsystem Qₙ. The initially selected subsystems may be selected by a user, e.g., before the implementation of the method in one example.

In one embodiment, the initial measurement step comprises the realization of the n₀-th local Positive Operator Valued Measure for exactly one initially selected subsystem Qₙ_{ₒ}. In another embodiment, the initial measurement step comprises for more than one initially selected subsystem Qₙ_{ₒ} the realization of a n₀-th local Positive Operator Valued Measure. The local Positive Operator Valued Measures realized on each of said initially selected subsystems Qₙ_{ₒ} may be different from another, or they may be identical to another. In one embodiment, where there is more than one initially selected subsystem Qₙ_{ₒ}, the respective n₀-th local Positive Operator Valued Measures may be implemented simultaneously on each of said initially selected subsystems Qₙ_{ₒ}. In this way, a speed-up of the method may be achieved. For example, there may be two initially selected subsystems Q₁ and Q₂, and a first local Positive Operator Valued Measure may be implemented on the first initially selected subsystem Q₁, and a second local Positive Operator Valued Measure may be implemented simultaneously or subsequently on the second initially selected subsystem Q₂.

The method further comprises an iterative measurement step, wherein for at least one iteratively selected subsystem Qₙ an n-th local Positive Operator Valued Measure is realized on said iteratively selected subsystem Qₙ. The iterative measurement step is implemented after the initial measurement step. In one embodiment, the iterative measurement step may comprise realizing the n-th local Positive Operator Valued Measure on exactly one selected subsystem Qₙ. In another embodiment, the iterative measurement step may comprise for a plurality of p iteratively selected subsystems Qₙ_{₁}, Qₙ_{₂}, . . . , Qₙ_{ₚ} a realization of an associated nₖ-th local Positive Operator Valued Measure k=1, . . . , p on the associated subsystem Qₙ_{ₓ}. The n-th local Positive Operator Valued Measure is realized by implementing, by operation of the quantum computing device, the potentially imperfect realization of the joint unitary operation Uₙₙ_{_{c}} followed by said joint quantum measurement described by said plurality of measurement operators on said joint system of said iteratively selected subsystem Qₙ and said at least one connected subsystem Qₙ_{_{c}}. The connected subsystem(s) is/are in a previously determined quantum state described by a density operator ρₙ_{_{c}} before the application of the joint unitary operation and the joint quantum measurement. I.e., the density operator ρₙ_{_{c}} describes the quantum state of the joint system of all connected subsystems Qₙ_{_{c}} of the subsystem Qₙ. It will be explained in more detail below how the at least one connected subsystem Qₙ_{_{c}} may be in the “previously determined quantum state”. The iteratively selected subsystems may be selected by a user, e.g., before and/or during the implementation of the method in one example.

The implementation of the joint unitary operation followed by the joint quantum measurement on said joint system indeed realizes a local Positive Operator Valued Measure on the subsystem Qₙ, as may be understood from the following (see e.g., A. Glos et. al., arxiv: 2208.07817.v1, Appendix B).

When the potentially imperfect realization of said joint unitary operation U_{n,n}_{_{c}} followed by said joint quantum measurement described by the measurement operators

$${M}_{{m}_{n , {n}_{c}}}^{( n , {n}_{c} )}$$

is implemented on sala joint system of the subsystem Qₙ and the at least one connected subsystem Qₙ_{_{c}}, the probability pₘ_{_{nnc}} to obtain the measurement outcome m_{n,n}_{_{c}}, is given by

$${p}_{{m}_{n , {n}_{c}}} = tr [ {M}_{{m}_{n , {n}_{c}}}^{( n , {n}_{c} )} {E}_{n , {n}_{c}} ( {ρ}_{n} ⊗ {ρ}_{{n}_{c}} ) {M}_{{m}_{n , {n}_{c}}}^{( n , {n}_{c} ) †} ] ,$$

wherein E_{n,n}_{_{c}} is the quantum channel describing the potentially imperfect realization of said joint unitary operation U_{n,n}_{_{c}}, ρₙ_{_{c}} is a density matrix representation of the reduced state of the subsystem Qₙ and ρₙ_{_{c}} is the density operator of the previously determined quantum state of the at least one connected subsystem Qₙ_{_{c}}.

$${M}_{{m}_{n , {n}_{c}}}^{( n , {n}_{c} ) †}$$

is the hermitian conjugate of the measurement operator

$${M}_{{m}_{n , {n}_{c}}}^{( n , {n}_{c} )} .$$

When a POVM measurement with effects

$${\prod }_{{m}_{n , {n}_{c}}}^{( n )} ( {E}_{n , {n}_{c}} , {M}_{{m}_{n , {n}_{c}}}^{( n , {n}_{c} )} ) = {\sum }_{{a}_{n}} {π}_{{a}_{n}}^{( n , {n}_{c} , {m}_{n , {n}_{c}} )} ( {E}_{n , {n}_{c}} , {M}_{{m}_{n , {n}_{c}}}^{( n , {n}_{c} )} ) {B}_{{a}_{n}}^{( n )}$$

having the associated measurement outcome m_{n,n}_{_{c}} is implemented on the subsystem Qₙ, wherein

$${π}_{{a}_{n}}^{( n , {n}_{c} , {m}_{n , {n}_{c}} )} ( {E}_{n , {n}_{c}} , {M}_{{m}_{n , {n}_{c}}}^{( n , {n}_{c} )} , {ρ}_{{n}_{c}} ) = tr [ {M}_{{m}_{n , {n}_{c}}}^{( n , {n}_{c} )} {E}_{n , {n}_{c}} ( {B}_{{a}_{n}}^{( n )} ⊗ {ρ}_{{n}_{c}} ) {M}_{{m}_{n , {n}_{c}}}^{( n , {n}_{c} ) †} ]$$

are coefficients,

$${B}_{{a}_{n}}^{( n )}$$

are basis operators of a local orthonormal basis of an operator space associated with a Hilbert space Hₙ of said subsystem Qₙ, and aₙ is the index of summation, the probability to obtain the measurement outcome mₙₙ_{_{c}} is given by

$${p}_{{m}_{n , {n}_{c}}}^{( P O V M )} = tr [ {\prod }_{{m}_{n , {n}_{c}}}^{( n )} ( {E}_{n , {n}_{c}} , {M}_{{m}_{n , {n}_{c}}}^{( n , {n}_{c} )} , {ρ}_{{n}_{c}} ) {ρ}_{n} ]$$

which is obviously the same probability as

$${p}_{{m}_{n , {n}_{c}}} = tr [ {M}_{{m}_{n , {n}_{c}}}^{( n , {n}_{c} )} {E}_{n , {n}_{c}} ( {ρ}_{n} ⊗ {ρ}_{{n}_{c}} ) {M}_{{m}_{n , {n}_{c}}}^{( n , {n}_{c} ) †} ] .$$

Thus, the measurement outcome mₙₙ_{_{c}} may be understood as the measurement outcome of a local POVM measurement associated with the effect

$${\prod }_{{m}_{n , {n}_{c}}}^{( n )} ( {E}_{n , {n}_{c}} , {M}_{{m}_{n , {n}_{c}}}^{( n , {n}_{c} )} )$$

defined above on the subsystem Qₙ. In one example, the measurement outcome m_{n,n}_{_{c}} may be provided to a classical computer for further data processing as described in more detail below.

According to the method of the first aspect of the present invention, for at least one iteratively selected subsystem Qₙ at least one of its connected subsystems Qₙ_{_{c}}, and preferably each of said connected subsystems Qₙ_{_{c}}, is one of said at least one initially selected subsystems Qₙ_{ₒ}. That is, for the subsystem Qₙ at least one, and preferably each, connected subsystem is such that a POVM has already been realized on said connected subsystem in the initial measurement step. For each subsystem Qₙ the system consisting of the at least one connected subsystem may be thus understood as “the ancilla system of the subsystem Qₙ”.

As at least one, and preferably all connected subsystems of the iteratively selected subsystem Qₙ are such that a local Positive Operator Valued Measure has been realized on at least one, and preferably each connected subsystem in the initial measurement step, fewer or even no additional ancilla systems are needed to implement the local POVM on the iteratively selected subsystem Qₙ contrary to what is known in the art of dilation. The reason is that in principle one can implement a POVM without ancillas, but this comes at a price, namely more rounds of measurements (shots) are required, or not every POVM can be implemented. In this way, the method according to the present invention is very resource-efficient.

In one embodiment, the imperfect realization of the joint unitary operation and the joint quantum measurement for at least one subsystem Qₙ is such that the local Positive Operator Valued Measure realized on the subsystem Qₙ is informationally complete. In a further example, the informationally complete Positive Operator Valued Measure may be a minimal informationally complete Positive Operator Valued Measure. If the local POVM is informationally complete, each observable O⁽ⁿ⁾ defined on the subsystem Qₙ may be expressed in terms of the local effects

$${\prod }_{{m}_{n , {n}_{c}}}^{( n )}$$

of the local PCVM according to

$${O}^{( n )} = {\sum }_{{m}_{n , {n}_{c}}} {ω}_{{m}_{n , {n}_{c}}} {\prod }_{{m}_{n , {n}_{c}}}^{( n )} ,$$

wherein

$${ω}_{{m}_{n , {n}_{c}}}$$

are coefficents. If the method according to the present invention is repeasted S times, a series of measurement outcomes

$${m}_{n , {n}_{c}}^{( 1 )} , … , {m}_{n , {n}_{c}}^{( s )}$$

is obtained tor the subsystem Qₙ. Then, an estimation for the value of the observable O⁽ⁿ⁾ may be obtained via the formula

$${\overline{O}}^{( n )} = \frac{1}{S} {\sum }_{s = 1}^{S} {ω}_{{m}_{n , {n}_{c}}^{( s )}} .$$

In one example, the value of the observable O⁽ⁿ⁾ may be the energy of the subsystem Qₙ, and the system quantum state may be a state of interest, e.g., a ground state of the system.

One example of the method according to the first aspect of the present invention is as follows: In the initial measurement step, a first local POVM is realized on the subsystem Q₁, a second local POVM is realized on the subsystem Q₂, and a third local POVM is realized on the subsystem Q₃. In the iterative measurement step, a fourth local POVM is realized on the subsystem Q₄, and a fifth local POVM is realized on the subsystem Q₅. The subsystem Q₄ has the connected subsystems Q₁ and Q₂. The fourth local POVM is realized on Q₄ by implementing a local unitary operation on the joint system of the subsystems Q₄, Q₁, Q₂ followed by a joint measurement on said joint system. The subsystem Q₅ has the connected subsystem Q₃, and the fifth local POVM is realized on Q₅ by implementing a local unitary operation on the joint system of the subsystems Q₅ and Q₃ followed by a joint quantum measurement on said joint system. In one example, the subsystems Q₁, . . . , Q₅ may be qubits.

According to an embodiment of the method of the present invention said iterative measurement step may be iterated, and the connectivity of the quantum computing device and the iteration may be such that for at least one of the iteratively selected subsystems Qₙ of said iteration, and preferably for each iteratively selected subsystem Qₙ, the n_{c}-th local Positive Operator Valued Measure has been previously realized on at least one, and preferably on each of said connected subsystems Qₙ_{_{c}} of said at least one iteratively selected subsystem Qₙ in a previous initial or iterative measurement step. According to the above embodiment, the iterative measurement step is repeated I≥2 times, i.e., the iterative measurement step is implemented I times. The first iterative measurement step is implemented after the initial measurement step, and for at least one, and preferably for each, iteratively selected subsystem Qₙ at least one, and preferably each, of said connected subsystems Qₙ_{_{c}}, is one of said at least one initially selected subsystems Qₙ_{ₒ}, as has been explained above. Then, for each iterative measurement step after the first iterative measurement step at least one, and preferably each, of the iteratively selected subsystems Qₙ of said iterative measurement step is such that the n_{c}-th local Positive Operator Valued Measure has been previously realized on at least one, and preferably on each, of said connected subsystems Qₙ_{_{c}} of said at least one iteratively selected subsystem Qₙ in a previous initial or iterative measurement step.

In one example of the above embodiment, the first iterative measurement step following the initial measurement step is such that for each iteratively selected subsystem Qₙ each of said connected subsystems Qₙ_{_{c}} is one of said at least one initially selected subsystems Qₙ_{ₒ}, and for each iterative measurement step subsequent to the first iterative measurement step the iteratively selected subsystem(s) Qₙ is/are such that the n_{c}-th local Positive Operator Valued Measure has been previously realized on each of said connected subsystems Qₙ_{_{c}} of said iteratively selected subsystem(s) Qₙ in a previous iterative measurement step.

In one example, there may be N≥4 quantum mechanical subsystems with a line-connectivity, i.e., for n=2, . . . , N, the subsystem Qₙ₋₁ is the connected subsystem of the subsystem Qₙ. Then, the initial measurement step may comprise implementing the 2^{nd} (2-th) local POVM on the subsystem Q₂ by implementing, by operation of the quantum computing device, the potentially imperfect realization of the joint unitary operation U_{2,1} followed by the joint quantum measurement described by the joint measurement operators

$${M}_{{m}_{2 , 1}}^{( 2 , 1 )}$$

on the joint system of the subsystem Q₂ and its connected subsystem Q₁, thereby obtaining the measurement outcome m_{2,1}. The connected subsystem Q₁ may be prepared in a predetermined quantum state described by the density operator ρ₁ before the application of the joint unitary operation. Then, the iterative measurement step is iterated I=N−2 times, and in the i-th iteration, i=1, . . . , N−2, the subsystem Qᵢ₊₂ is the iteratively selected subsystem, and the (i+2)-th local POVM is realized on the subsystem Qᵢ₊₂ by implementing, by operation of the quantum computing device, the potentially imperfect realization of the joint unitary operation U_{i+2,i+1} followed by the joint quantum measurement described by the measurement operators

$${M}_{{m}_{i + 2 , i + 1}}^{( i + 2 , i + 1 )}$$

on the joint system of the iteratively selected subsystem Qᵢ₊₂ and its connected subsystem Qᵢ₊₁ to thereby obtain a measurement outcome m_{i+2,i+1}.

According to the above embodiment, initial and/or iteratively selected subsystems of a previous initial or iterative measurement step serve as ancilla systems for implementing the respective n-th local Positive Operator Valued Measure on the subsystem Qₙ. In this way, the above embodiment is very resource efficient, as no further ancilla systems in addition to the plurality of quantum mechanical subsystems of the composite system is required for the iterative measurement steps.

In one embodiment of the method according to the present invention said iteration is terminated when for each subsystem Qₙ the respective n-th local Positive Operator Valued Measure has been realized. For this embodiment it is preferred that for each iteratively selected subsystem Qₙ of one of the iterative measurement steps the n_{c}-th local Positive Operator Valued Measure has been previously realized on each of said connected subsystems Qₙ_{_{c}} of said iteratively selected subsystem Qₙ in a previous initial or iterative measurement step. Then, if the system quantum state of the composite quantum system is described by a density operator p before the initial measurement step, the method implements a POVM measurement of said system quantum state described by global effects which are tensor products of local POVM effects associated with the respective initially and iteratively selected subsystems

$${Q}_{{n}_{0}} , {Q}_{n} , {\prod }_{m} = {⊗}_{{n}_{0} ∈ {S}_{IN}} {\prod }_{{m}_{{n}_{0}}}^{( {n}_{0} )} {⊗}_{n ∈ {S}_{IT}} {\prod }_{{m}_{n , {n}_{c}}}^{( n )} ( {E}_{n , {n}_{c}} , {M}_{{m}_{n , {n}_{C}}}^{( n , {n}_{c} )} , {ρ}_{{n}_{c}} )$$

with associated measurement outcome come

$$m = ( {( {m}_{{n}_{0}} )}_{{n}_{0} ∈ {S}_{IN}} , {( {m}_{n , {n}_{c}} )}_{n ∈ {S}_{IT}} ) .$$

Here,

$${\prod }_{{m}_{{n}_{0}}}^{( {n}_{0} )}$$

is the effect of the n₀-th local POVM realized on the initial subsystem Qₙ_{₀} with measurement outcome mₙ_{₀}, S_{IN} is the set of indices of the initially selected subsystems,

$${\prod }_{{m}_{n , {n}_{c}}}^{( n )}$$

is the effect of the n-th local POVM related on the iteratively selected subsystem Qₙ with measurement outcome m_{n,n}_{_{c}} and S_{IT} is the set of indices of the iteratively selected subsystems.

If each of the local POVMs is informationally complete, the global effects Πₘ describe an informationally complete POVM as well. Then, each observable O which is defined on the composite system may be expressed in terms of these global effects according to O=ΣₘωₘΠₘ with coefficients ωₘ. If the method according to the present embodiment is repeated S times, a sequence of measurement outcomes m₁, . . . , mₛ is obtained. Then, an estimator for the value of the observable O may be obtained via the formula

$$\overline{O} = \frac{1}{S} {\sum }_{s = 1}^{S} {ω}_{{m}_{s}} .$$

For example, an estimate of the total energy of the system may be obtained in this way.

In another embodiment of the method according to the present invention, said connectivity and said operativity of said quantum computing device may be such that for at least one subsystem Qₙ, and preferably for each subsystem, the potentially imperfect realization of said joint unitary operation U_{n,n}_{_{c}} on said joint system is by an application of a sequence of local unitary operations, wherein each local unitary operation is acting on at most two subsystems of said joint system. In this case, the means for applying the joint unitary operation may be operative to apply the sequence of local unitary operations on the joint subsystem. In an example where all subsystems are qubits, each local unitary operation may be either a single-qubit gate or a two-qubit gate. These gates may be realized with high accuracy in state-of-the art quantum computing devices, including, but not limited to superconducting quantum computing devices.

In the initial measurement step of the method according to the present invention, the n₀-th local POVM is realized on the at least one initially selected subsystem Qₙ_{₀}. The way how the n₀-th local POVM is realized is not limited. However, in certain examples it is preferable that the n₀-th local POVM is realized in the same way as the n-th local POVM on the iteratively selected subsystems, namely by applying a joint unitary operation on a joint system of said initially selected subsystem Qₙ_{₀} and the at least one connected subsystem of said initially selected subsystem Qₙ_{₀} followed by a joint measurement on said joint system. Thus, according to another embodiment of the method of the present invention, said plurality of subsystems may be partitioned in a system subset and an ancillary subset which is a complement of said system subset such that said ancillary subset comprises the at least one connected subsystem Qₙ_{_{sc}} of at least one starting subsystem Qₙ_{_{sc}} in said system subset, wherein for each starting subsystem Qₙ_{ₛ} the previously determined quantum state of said at least one connected subsystem Qₙ_{_{sc}} may be a predetermined quantum state described by the density operator ρₙ_{_{sc}} and wherein said connectivity and said operativity of said quantum computing device may further allow to prepare said system quantum state by preparing the plurality of subsystems in said system subset in a desired solution state, preferably by quantum gate application, and by preparing for each starting subsystem Qₙ_{ₛ} the at least one connected subsystem Qₙ_{_{sc}} of said ancillary subset in the predetermined quantum state described by the density operator ρₙ_{_{sc}}, wherein said method may further comprise:
preparing said system quantum state by operation of said quantum computing device;
and wherein the at least one initially selected subsystem Qₙ_{₀} comprises said at least one starting subsystem Qₙ_{ₛ}, and wherein for each of said starting subsystems Qₙ_{ₛ} the realization of the nₛ-th local Positive Operator Valued Measure in the initial measurement step is by implementing, by operation of said quantum computing device, said potentially imperfect realization of said joint unitary operation Uₙ_{ₛ}ₙ_{_{sc}} followed by said joint quantum measurement described by said plurality of measurement operators

$${M}_{{m}_{{n}_{s} , {n}_{s c}}}^{( {n}_{s} , {n}_{s c} )}$$

on said joint system or said starting subsystem Qₙ_{ₛ} and said at least one connected subsystem Qₙ_{_{sc}} which is in the previously determined quantum state described by the density operator ρₙ_{_{sc}}, to thereby obtain a measurement outcome mₙ_{ₛ}ₙ_{_{sc}}.

According to the above embodiment, the plurality of subsystems Qₙ is partitioned into two subsets, namely the system subset and the ancillary subset. The composite system of the plurality of subsystems Qₙ in the system subset may be prepared in a desired solution state by the quantum computing device. The solution state may be a state of interest, e.g., a quantum state encoding the solution of a quantum computation. The subsystems in the ancillary subset may be considered as ancilla systems which are used to implement the n₀-th local Positive Operator Valued Measure on at least one initially selected subsystem Qₙ_{₀}. Therefore, the ancillary subset is such that it comprises for at least one starting subsystem Qₙ_{ₛ} in the system subset at least one, and preferably all connected subsystems Qₙ_{_{sc}}, of said starting subsystem Qₙ_{ₛ}. When there is a plurality of initially selected subsystems in the initial measurement step, the ancillary subset comprises preferably all connected subsystems of the plurality of initially selected subsystems. In one example at least one subsystem in the ancillary subset is also the connected subsystem or one of the connected subsystems of an iteratively selected subsystem. I.e., said subsystem in the ancillary subset is used at least twice for the implementation of a local POVM, once in the initial measurement step and then in an iterative measurement step.

In one example of the above embodiment it may be preferable that said iteration is terminated when for each subsystem Qₙ in said system subset the local Positive Operator Valued Measure has been realized. Then, the method implements a POVM measurement of said solution state described by global effects which are tensor products of local POVM effects associated with the respective initially and iteratively selected subsystems as has been explained above.

In one example, the order in which the subsystems are iteratively selected in the iterative measurement step may be predetermined. However, the invention is not limited to this. In another embodiment of the method according to the present invention at least one iterative measurement step, and preferably each iterative measurement step, comprises selecting the iteratively selected subsystems Qₙ on the basis of the measurement outcome of a preceding initial or iterative measurement step. I.e., the order in which the subsystems are iteratively selected is decided during the measurement itself. In this way, the class of (global) POVMs that can be implemented is larger, because by changing the order of qubits measured we change the correlation structure. This has the potential of providing POVM candidate which with the same number of classical outcomes allows to estimate the energy with higher precision.

Before the joint unitary operation is applied to the joint system of the subsystem Qₙ and the at least one connected subsystem Qₙ_{_{c}}, the quantum state of the at least one connected subsystem Qₙ_{_{c}} is a previously determined quantum state described by a density operator ρₙ_{_{c}}. In one embodiment of the method according to the present invention, the method is such that for at least one, and preferably for each, iteratively selected subsystem Qₙ the previously determined quantum state of said connected subsystem Qₙ_{_{c}} may be a predetermined quantum state described by the predetermined density operator ρₙ_{_{c}}, and said method may further comprise preparing the at least one connected subsystem Qₙ in said predetermined quantum state before the realization of the n-th local Positive Operator Valued Measure on said at least one iteratively selected subsystem Qₙ in the iterative measurement step. The predetermined quantum state may be determined in advance before the iterative measurement step is implemented. In one example, the quantum computing device may comprise state preparation means for preparing the at least one connected subsystem Qₙ_{_{c}} of the iteratively selected subsystem Qₙ in the predetermined quantum state, and said method may further comprise preparing said at least one connected subsystem Qₙ_{_{c}} in the predetermined quantum state by operation of said state preparation means.

In one example of the above embodiment, said predetermined quantum state may be a pure quantum state. In one example where the subsystems are qubits with the two levels described by the pure state vectors |0 [symbol] and |1 [symbol] , the predetermined quantum state may be one of the two levels, i.e., it may be the quantum state described by the state vectors |0 [symbol] or |1 [symbol] .

When the previously determined quantum state is the predetermined quantum state, the quantum channel E_{n,n}_{_{c}} describing the potentially imperfect realization of the joint unitary operation U_{n,n}_{_{c}} and the measurement operators

$${M}_{{m}_{n , {n}_{c}}}^{( n , {n}_{c} )}$$

describing the joint quantum measurement on the joint quantum system of the subsystem Qₙ and the at least one connected subsystem Qₙ_{_{c}}, are known, e.g., they are determined by Quantum Process Tomography and/or Quantum Detector Tomography, one knows that a local POVM is implemented on the subsystem Qₙ, the local POVM being described by effects

$${\prod }_{{m}_{n , {n}_{c}}}^{( n )} ( {E}_{n , {n}_{c}} , {M}_{{m}_{n , {n}_{c}}}^{( n , {n}_{c} )} ) = {\sum }_{{a}_{n}} {π}_{{a}_{n}}^{( n , {n}_{c} , {m}_{n , {n}_{c}} )} ( {E}_{n , {n}_{c}} , {M}_{{m}_{n , {n}_{c}}}^{( n , {n}_{c} )} ) {B}_{{a}_{n}}^{( n )} , wherein$$

$${π}_{{a}_{n}}^{( n , {n}_{c} , {m}_{n , {n}_{c}} )} ( {E}_{n , {n}_{c}} , {M}_{{m}_{n , {n}_{c}}}^{( n , {n}_{c} )} , {ρ}_{{n}_{c}} ) = tr [ {M}_{{m}_{n , {n}_{c}}}^{( n , {n}_{c} )} {E}_{n , {n}_{c}} ( {B}_{{a}_{n}}^{( n )} ⊗ {ρ}_{{n}_{c}} ) {M}_{{m}_{n , {n}_{c}}}^{( n , {n}_{c} ) †} ]$$

are coefficients and

$${B}_{{a}_{n}}^{( n )}$$

are basis operators of a local orthonormal basis of an operator space associated with a Hilbert space Hₙ of said subsystem Qₙ. If in one embodiment it is the goal to implement a certain n-th local POVM on the subsystem Qₙ, the quantum computing device may be constructed such that it is operative to implement the joint local unitary operation and the joint quantum measurement that result in a certain local POVM for a certain predetermined quantum state of the at least one connected subsystem Qₙ_{_{c}} of the subsystem Qₙ.

According to a further embodiment of the method of the present invention, said quantum computing device may be further operative to implement for at least one of said subsystems Qₙ, and preferably for each subsystem Qₙ, a plurality of Pₙ potentially imperfect realizations of joint unitary operations

$${U}_{n , {n}_{c}}^{( p )} ,$$

p=1, . . . , Pₙ, and a plurality of Rₙ joint quantum measurements on the joint system of said subsystem Qₙ and the at least one connected subsystem Qₙ_{_{c}}, said realization of said r-th joint quantum measurement, r=1, . . . , Rₙ, being described by a plurality of measurement operators

$${M}_{{m}_{n , {n}_{c}}}^{( r , n , {n}_{c} )} ,$$

each measurement operator

$${M}_{{m}_{n , {n}_{c}}}^{( r , n , {n}_{c} )}$$

being associated with a measurement outcome

$${m}_{n , {n}_{c}}^{( r )} ,$$

and wherein said realization of said n-th local Positive Operator Valued Measure on said subsystem Qₙ comprises selecting one of said joint unitary operations

$${U}_{n , {n}_{c}}^{( p )}$$

of said plurality anu selecting one of said joint quantum measurements of said plurality described by the measurement operators

$${M}_{{m}_{n , {n}_{c}}}^{( r , n , {n}_{c} )}$$

and implementing, by operation of said quantum computing device, said potentially imperfect realization of said selected joint unitary operation

$${U}_{n , {n}_{c}}^{( p )}$$

followed by said selected joint quantum measurement described by said plurality of measurement operators

$${M}_{{m}_{n , {n}_{c}}}^{( r , n , {n}_{c} )}$$

on said joint system of said iteratively selected subsystem Qₙ and said at least one connected subsystem Qₙ_{_{c}}. According to this embodiment, the quantum computing device is operative to implement not only a single but a plurality of potentially imperfect realizations of different joint unitary operations and different joint quantum measurements on the joint system. In one example, the quantum computing device may be operative to implement a potentially imperfect realization of a continuous or discrete parametric family of joint unitary operations U_{n,n}_{_{c}}(λₙ) with a continuous or discrete one- or multidimensional parameter λₙ for at least one, and preferably for each subsystem Qₙ. Additionally or alternatively, the quantum computing device may be operative to implement a continuous or discrete parametric family of joint quantum measurements described by measurement operators

$${M}_{{m}_{n , {n}_{c}}}^{( n , {n}_{c} )} ( {μ}_{n} )$$

with discrete or continuous one- or multidimensional parameter μₙ for at least one, and preferably for each subsystem Qₙ.

In one example of the above embodiment, the selection may be on the basis of the measurement outcome of a preceding initial or iterative measurement step and/or said selection may be a random selection.

As has been explained above, the previously determined quantum state of the at least one connected subsystem may be a predetermined quantum state in one embodiment. However, the invention is not limited to this. In another embodiment of the method of the present invention, the method may further be such that for at least one iteratively selected subsystem Qₙ, and preferably for each iteratively selected subsystem Qₙ, the n_{c}-th local Positive Operator Valued Measure has been realized on the at least one connected subsystem Qₙ_{_{c}} with measurement outcome mₙ_{_{c}} in the initial measurement step or in one of the previous iterative measurement steps, the previously determined quantum state of the at least one connected subsystem Qₙ_{_{c}} may be the state of said at least one connected subsystem Qₙ_{_{c}} after the realization of the n_{c}-th local Positive Operator Valued Measure on said connected subsystem Qₙ_{_{c}}, and said method may further comprise inferring the reduced density operator ρₙ_{_{c}} of said at least one connected subsystem Qₙ_{_{c}} on the basis of said measurement outcome mₙ_{_{c}}. I.e., according to the above embodiment, the previously determined quantum state of the at least one connected subsystem may be determined by the measurement outcome of the realization of the n_{c}-th local Positive Operator Valued Measure on said at least one connected subsystem Qₙ_{_{c}}. When there is more than one connected subsystem Qₙ_{_{c}}, the measurement outcome mₙ_{_{c}} consists of the measurement outcomes for the realization of the local POVM on each of the connected subsystems. In this way, no additional state preparation of the at least one connected subsystem is required, thereby increasing the efficiency of the method.

The result of this method is illustrated in the following using the example of the N≥4 quantum mechanical subsystems with the line-connectivity introduced above. Recall that in the initial measurement step the measurement outcome m_{2,1} is obtained, and in the i-th iteration the measurement outcome m_{i+2,i+1} is obtained for the implementation of the (i+2)-th local POVM on the subsystem Qᵢ₊₂. It may be possible to infer the reduced density operator ρᵢ₊₂ of the subsystem Qᵢ₊₂ after the realization of the nᵢ₊₂-th local POVM from the measurement outcome m_{i+2,i+1}. For example, when the joint quantum measurement on the subsystem Qᵢ₊₂ is a local quantum measurement (see, e.g., G. Aubrun and C. Lancien in QIC, Vol. 15, No. 5-6, 512-540 (2015)) with measurement operators

$${M}_{{m}_{i + 2 , i + 1}}^{( i + 2 , i + 1 )} = {M}_{{m}_{i + 2}}^{( i + 2 )} ⊗ {M}_{{m}_{i + 1}}^{( i + 1 )} , wherein {M}_{{m}_{i + 2}}^{( i + 2 )} = \vert {m}_{i + 2} 〉 〈 {m}_{i + 2} \vert$$

is a projective measurement operator on the eigenstate |mᵢ₊₂ [symbol] of the subsystem Qᵢ₊₂ with measurement outcome mᵢ₊₂, and

$${M}_{{m}_{i + 1}}^{( i + 1 )} = \vert {m}_{i + 1} 〉 〈 {m}_{i + 1} \vert$$

is a projective measurement operator on the eigenstate |mᵢ₊₁ [symbol] of the subsystem Qᵢ₊₁ with measurement outcome mᵢ₊₁, the state of the subsystem Qᵢ₊₂ after the application of the joint quantum measurement is described by the state vector |mᵢ₊₂ [symbol] . This is the state of the connected subsystem Qᵢ₊₂ of the iteratively selected subsystem Qᵢ₊₃ in the next iterative measurement step. Thus, when the iterative measurement step is iterated until the nᵢ-th local POVM is realized on all subsystems Qᵢ, i=2, . . . , N, a sequence of measurement outcomes m_{2,1}, m_{3,2} . . . , m_{N,N-1} is obtained. When the subsystem Q₁, which is the connected subsystem of the initially selected subsystem Q₂ is prepared in the predetermined quantum state described by the density operator ρ₁ before the implementation of the initial measurement step, the POVM with the following effects is implemented on the subsystems Q₂, . . . , Q_{N}:

$${Π}_{{m}_{2 , 1}}^{( {ρ}_{1} )} ⊗ {Π}_{{m}_{3 , 2}}^{( {m}_{2 , 1} )} ⊗ {Π}_{{m}_{4 , 3}}^{( {m}_{3 , 2} )} ⊗ … ⊗ {Π}_{{m}_{N , N - 1}}^{( {m}_{N - 1 , N - 2} )} , wherein {Π}_{{m}_{2 , 1}}^{( {ρ}_{1} )} = {\sum }_{{a}_{2}} {π}_{{a}_{2}}^{( {ρ}_{1} , {m}_{2 , 1} )} {B}_{{a}_{2}}^{( 2 )}$$

is the 2-th local POVM implemented in the initial measurement step, with coefficient

$${π}_{{a}_{2}}^{( {ρ}_{1} , {m}_{2 , 1} )} = tr [ {E}_{2 , 1} ( {B}_{{a}_{2}}^{( 2 )} ⊗ {ρ}_{1} ) {M}_{{m}_{2 , 1}}^{( 2 , 1 )} ] , wherein {B}_{{a}_{2}}^{( 2 )}$$

are basis operators of a local orthonormal basis of an operator space associated with a Hilbert space H₂ of the initially selected subsystem Q₂, and

$${Π}_{{m}_{i + 2 , i + 1}}^{( {m}_{i + 1 , i} )} = {\sum }_{{a}_{i + 2}} {π}_{{a}_{i + 2}}^{( {m}_{i + 2 , i + 1} , {m}_{i + 1 , i} )} {B}_{{a}_{i + 2}}^{( i + 2 )}$$

is the (i+2)-th local POVM implemented on the iteratively selected subsystem Qᵢ₊₂ in the i+th iterative measurement step, i=2, . . . , N, with coefficients

$${π}_{{a}_{i + 2}}^{( {m}_{i + 2 , i + 1} , {m}_{i + 1 , i} )} = tr [ {E}_{i + 2 , i + 1} ( {B}_{{a}_{i + 2}}^{( i + 2 )} ⊗ {ρ}_{i + 1} ) {M}_{{m}_{i + 2 , i + 1}}^{( i + 2 , i + 1 )} ] , wherein {B}_{{a}_{i + 2}}^{( i + 2 )}$$

are basis operators of a local orthonormal basis of an operator space associated with a Hilbert space Hᵢ₊₂ of the iteratively selected subsystem Qᵢ₊₂.

In another embodiment of the method of the present invention, the method may be such that for at least one iteratively selected second subsystem Qₙ_{₂} of a second iterative measurement step the at least one connected subsystem Qₙ_{_{1,2c}} is also the at least one connected subsystem Qₙ_{_{1,2c}} of a previously selected first subsystem Qₙ_{₁} of a previous iterative measurement step, the previously determined quantum state of said at least one connected subsystem Qₙ_{_{1,2c}} in said second iterative measurement step being the state of said at least one connected subsystem Qₙ_{_{1,2c}} after the realization of said n₁-th local Positive Operator Valued Measure on said first subsystem Qₙ_{₁} in said previous iterative measurement step, and said method further comprises inferring the reduced density operator of the at least one connected subsystem Qₙ_{_{1,2c}} in the second iterative measurement step on the basis of said measurement outcome mₙ_{₁}_{,n}_{_{1,2c}} which is obtained when realizing the n₁-th local Positive Operator Valued Measure on said first subsystem Qₙ_{₁} in said previous iterative measurement step. According to this embodiment, the at least one connected subsystem Qₙ is the connected subsystem of the first and second subsystems Qₙ_{₁},Qₙ_{₂}, and thus used twice as an ancilla system for implementing the n₁-th and the n₂-th local POVM on the subsystems Qₙ_{₁} and Qₙ_{₂}.

For the subsystem Qₙ, the measurement operators of the associated joint quantum measurement are not limited, in principle. In one embodiment, the plurality of measurement operators

$${M}_{{m}_{n , {n}_{c}}}^{( n , {n}_{c} )}$$

for at least one subsystem Qₙ, and preferably the measurement operators for each subsystem Qₙ, describe a potentially imperfect realization of a projective measurement, and preferably said measurement operators

$${M}_{{m}_{n , {n}_{c}}}^{( n , {n}_{c} )}$$

describe a realization of a projective measurement. For example, the measurement operator

$${M}_{{m}_{n , {n}_{c}}}^{( n , {n}_{c} )}$$

may be a projector on an eigenstate |mₙ, mₙ_{_{c}} [symbol] of the joint system of the subsystem Qₙ and the connected subsystem Qₙ_{_{c}}.

In a further embodiment the joint quantum measurement for at least one subsystem Qₙ, and preferably for each subsystem, may be a local quantum measurement with respect to the subsystem Qₙ and the at least one connected subsystem Qₙ_{_{c}} of said joint system so that each measurement operator

$${M}_{{m}_{n , {n}_{c}}}^{( n , {n}_{c} )}$$

of said plurality is a tensor product of measurement operators,

$${M}_{{m}_{n , {n}_{c}}}^{( n , {n}_{c} )} = {M}_{{m}_{n}}^{( n )} ⊗ {M}_{{m}_{{n}_{c}}}^{( {n}_{c} )} , wherein {M}_{{m}_{n}}^{( n )}$$

is a measurement operator of a first quantum measurement defined on the subsystem Qₙ with associated measurement outcome mₙ and

$${M}_{{m}_{{n}_{c}}}^{( {n}_{c} )}$$

is a measurement operator of a second quantum measurement defined on the at least one connected subsystem Qₙ_{_{c}} with associated measurement outcome mₙ_{_{c}}, and preferably the quantum measurement is local respect to each subsystem of said joint system, i.e., the measurement operators

$${M}_{{m}_{n , {n}_{c}}}^{( n , {n}_{c} )}$$

are tensor products of measurement operators of quantum measurements on each subsystem of said joint system.

I.e., the first quantum measurement on the subsystem Qₙ is defined by measurement operators

$${M}_{{m}_{n}}^{( n )}$$

that fulfil

$${\sum }_{{m}_{n}} {M}_{{m}_{n}}^{( n ) †} {M}_{{m}_{n}}^{( n )} = 𝟙 ,$$

and the second quantum measurement on the at least one connected subsystem Qₙ_{_{c}} is defined by measurement operators that fulfil

$${\sum }_{{m}_{{n}_{c}}} {M}_{{m}_{{n}_{c}}}^{( {n}_{c} ) †} {M}_{{m}_{{n}_{c}}}^{( {n}_{c} )} = 𝟙 .$$

When there are N_{c} connected subsystems Qₙ_{_{c}}, e.g., the subsystems Qₖ with k=1, . . . , N_{c}, for the subsystem Qₙ, the measurement on these connected subsystems is preferably described by N_{c} local quantum measurements, i.e.,

$${\sum }_{{m}_{k}} {\tilde{M}}_{{m}_{k}}^{( k ) †} {\tilde{M}}_{{m}_{k}}^{( k )} = 𝟙 .$$

is a measurement operator of a quantum measurement on the subsystem Qₖ with measurement outcome mₖ, i.e.,

$${M}_{{m}_{{n}_{c}}}^{( {n}_{c} )} = {⊗}_{k = 1}^{{N}_{c}} {\tilde{M}}_{{m}_{k}}^{( k )} , wherein {\tilde{M}}_{{m}_{k}}^{( k )}$$

Local measurements are defined, for the general case of POVMs, in G. Aubrun an C. Lancien, “Locally restricted measurements on a multipartite quantum system: data hiding is generic”, QIC, Vol. 15, No. 5-6, 512-540 (2015).

In one preferred example, the joint quantum measurement for the subsystem Qₙ is a local projective measurement, wherein each measurement operator

$${M}_{{m}_{n}}^{( n )}$$

is a projector on an eigenstate |mₙ [symbol] of the subsystem Qₙ, and each measurement operator

$${M}_{{m}_{{n}_{c}}}^{( {n}_{c} )}$$

is a projector on an eigenstate |mₙ_{_{c}} [symbol] of the at least one connected subsystem Qₙ_{_{c}}.

In a further embodiment of the method according to the present invention, said realization of said joint unitary operation U_{n,n}_{_{c}} may be a perfect realization of said joint unitary operation U_{n,n}_{_{c}} for at least one subsystem Qₙ, and preferably for each subsystem Qₙ.

In one embodiment, the method may further comprise for at least one, and preferably for each initially or iteratively selected subsystem Qₙ:
a. providing the following input to a classical computer:
   the measurement outcome m_{n,n}_{_{c}} and a representation of the associated measurement operator

$${M}_{{m}_{n , {n}_{c}}}^{( n , {n}_{c} )} ;$$

a representation of a quantum channel E_{n,n}_{_{c}} describing the potentially imperfect realization of said joint unitary operation U_{n,n}_{_{c}};
a representation of the reduced density operator ρₙ_{_{c}} of said at least one connected subsystem Qₙ_{_{c}};
a representation of basis operators

$${B}_{{a}_{n}}^{( n )}$$

of a local orthonormal basis of an operator space associated with a Hilbert space Hₙ of said subsystem Qₙ;
b. calculating, by the classical computer, a representation of a local effect

$${\prod }_{{m}_{n , {n}_{c}}}^{( n , {n}_{c} )} = {\sum }_{{a}_{n}} {π}_{{a}_{n}}^{( n , {n}_{c} , {m}_{n , {n}_{c}} )} {B}_{{a}_{n}}^{( n )}$$

associated with the local Positive Operator Valued Measure realized on said selected subsystem Qₙ, wherein the coefficients

$${π}_{{a}_{n}}^{( n , {n}_{c} , {m}_{n , {n}_{c}} )} = tr [ {M}_{{m}_{n , {n}_{c}}}^{( n , {n}_{c} )} {E}_{n , {n}_{c}} ( {B}_{{a}_{n}}^{( n )} ⊗ {ρ}_{{n}_{c}} ) {M}_{{m}_{n , {n}_{c}}}^{( n , {n}_{c} ) †} ]$$

are given by a trace over a product of an image of a tensor product of the basis operator

$${B}_{{a}_{n}}^{( n )}$$

and the reduced density operator ρₙ_{_{c}} under the quantum channel E_{n,n}_{_{c}}, and the measurement operator

$${M}_{{m}_{n , {n}_{c}}}^{( n , {n}_{c} )}$$

and its hermitian conjugate.

The representation of the calculated local effect

$${\prod }_{{m}_{n , {n}_{c}}}^{( n , {n}_{c} )}$$

may be output by the classical computer. Additionally, or alternatively, an expectation value of an observable quantity O⁽ⁿ⁾ defined on the subsystem Qₙ may be calculated using the representation of the local effect, as has been explained above.

According to a second aspect of the present invention, there is provided Quantum computing device, said quantum computing device comprising a composite system comprising a plurality of quantum mechanical subsystems Qₙ, n=1, . . . , N, N≥2, said quantum mechanical subsystems being preferably qubits, and said quantum computing device having a connectivity and operativity that allows to implement for each of said subsystems Qₙ a potentially imperfect realization of a joint unitary operation Uₙₙ_{_{c}} and a joint quantum measurement on a joint system of said subsystem Qₙ and at least one connected subsystem Qₙ_{_{c}} of said plurality of subsystems, said realization of said joint quantum measurement being described by a plurality of measurement operators

$${M}_{{m}_{n , {n}_{c}}}^{( n , {n}_{c} )} ,$$

each measurement operator

$${M}_{{m}_{n , {n}_{c}}}^{( n , {n}_{c} )}$$

being associated with a measurement outcome m_{n,n}_{_{c}},
said quantum computing device further comprising means for realizing an n₀-th local Positive Operator Valued Measure on at least one initially selected subsystem Qₙ_{₀} to thereby obtain a measurement outcome mₙ_{₀}, and a controller,
wherein said quantum computing device is operative, by control of the controller, to implement an initial measurement step which comprises for at least one initially selected subsystem Qₙ_{₀} the realization of the n₀-th local Positive Operator Valued Measure on said initially selected subsystem Qₙ_{₀} to thereby obtain the measurement outcome mₙ_{₀} and to implement an iterative measurement step which comprises for at least one iteratively selected subsystem Qₙ a realization of an n-th local Positive Operator Valued Measure on said iteratively selected subsystem Qₙ by implementing, by operation of said quantum computing device, said potentially imperfect realization of said joint unitary operation U_{n,n}_{_{c}} followed by said joint quantum measurement described by said plurality of measurement operators

$${M}_{{m}_{n , {n}_{c}}}^{( n , {n}_{c} )}$$

on said joint system of said iteratively selected subsystem Qₙ and said at least one connected subsystem Qₙ_{_{c}}, wherein said at least one connected subsystem Qₙ_{_{c}} is in a previously determined quantum state described by a density operator ρₙ_{_{c}}, to thereby obtain a measurement outcome m_{n,n}_{_{c}},
wherein for at least one iteratively selected subsystem Qₙ at least one of said connected subsystems Qₙ_{_{c}}, and preferably each of said connected subsystems Qₙ_{_{c}}, is one of said at least one initially selected subsystems Qₙ_{₀}.

The quantum computing device according to the second aspect of the present invention is configured to implement the method according to the first aspect of the present invention. Everything that has been said above in relation to the method of the first aspect also applied to the apparatus of the second aspect.

### BRIEF DESCRIPTION OF THE DRAWINGS

In the following, the invention is explained in greater detail by way of example with reference to the drawings. In the drawings,

FIG. 1 depicts a schematic representation of a system comprising an embodiment of a quantum computing device according to the second aspect of the present invention and a classical computer,

FIG. 2 depicts a quantum circuit for implementing a first embodiment of the method according to the first aspect of the present invention, and

FIG. 3 schematically depicts the implementation of said quantum circuit on a system of five qubits arranged in a linear topology,

FIG. 4 depicts a quantum circuit for implementing a second embodiment of the method according to the first aspect of the present invention,

FIG. 5a-5c schematically represents the iterative selection of subsystems of a composite system according to an embodiment of the method according to the first aspect of the present invention,

FIG. 6a-6e schematically represents the iterative selection of subsystems of a composite system according to another embodiment of the method according to the first aspect of the present invention.

### DETAILED DESCRIPTION

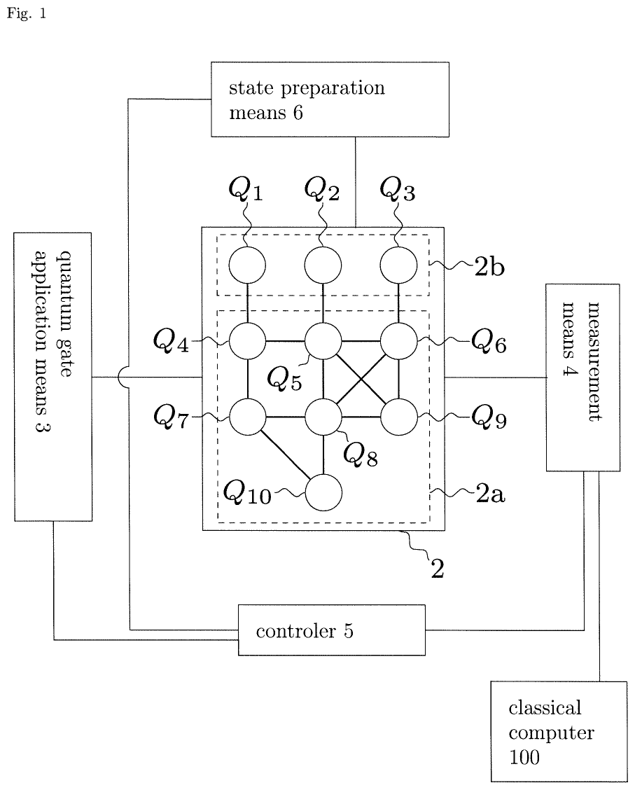

FIG. 1 depicts a schematic representation of a system comprising an embodiment of a quantum computing device 1 according to the second aspect of the present invention and a classical computer 100. The quantum computing device 1 comprises a composite system 2 of a plurality of N=10 quantum mechanical subsystems Qₙ indicated by circles in FIG. 1. For illustrative purposes, it is assumed in the following that each quantum mechanical subsystem Qₙ is a qubit, but the invention is not limited to this. Each qubit is a two-level system wherein one of the two states may be denoted by the pure state vector |0 [symbol] and the other state may be denoted by the pure state vector |1 [symbol] .

The quantum mechanical subsystems Qₙ of said plurality are partitioned in a system subset 2a consisting of the qubits Q₄, . . . , Q₁₀ and an ancillary subset 2b consisting of the qubits Q₁, Q₂, Q₃.

The quantum computing device 1 according to the second aspect of the present invention has a connectivity and operativity that allows to implement for each of said subsystems Qₙ_{_{c}} by control of a controller 5 of the quantum computing device 1, a potentially imperfect realization of a joint unitary operation U_{n,n}_{_{c}} and a joint quantum measurement on a joint system of said subsystem Qₙ and at least one connected subsystem Qₙ_{_{c}} of said plurality of subsystems, said realization of said joint quantum measurement being described by a plurality of measurement operators

$${M}_{{m}_{n , {n}_{c}}}^{( n , {n}_{c} )} ,$$

each measurement operator

$${M}_{{m}_{n , {n}_{c}}}^{( n , {n}_{c} )}$$

being associated with a measurement outcome m_{n,n}_{_{c}}. To this end, the embodiment of the quantum computing device 1 shown in FIG. 1 comprises quantum gate application means 3 and measurement means 4.

The quantum gate application means 3 is operative, by control of the controller 5, to implement a potentially imperfect realization of a single-qubit unitary operation

$${U}_{n}^{( 1 )}$$

on each of Saiu quuns, anu a two-qubit unitary operation

$${U}_{n , {n}^{′}}^{( 2 )}$$

on a joint system of two qubits Qₙ and Q_{n′} which are connected by a solid line in FIG. 1.

The measurement means 4 is operative, by control of the controller 5, to implement for each subsystem Qₙ a local quantum measurement described by a plurality of measurement operators

$${M}_{{m}_{n}}^{( n )}$$

with associated measurement outcome mₙ. In one example, the measurement operators

$${M}_{{m}_{n}}^{( n )}$$

are projectors on the eigen-states |mₙ [symbol] , mₙ=n 0.1, of the respective qubit.

For the embodiment shown in FIG. 1, the at least one connected subsystem, the joint unitary operation and the measurement operators of the joint quantum measurement of each subsystem Qₙ in the system subset 2a may be as shown in Table 1 in one example, wherein [symbol] , denotes the identity operation on the subsystem Q_{n′}:

| | connected | | joint quantum |
|---|---|---|---|
| sub- | sub- | joint unitary | measure- |
| system | system(s) | operation | ment |
| Q₄ | Q₁ | ${U}_{4 , 1} = {U}_{4 , 1}^{( 2 )}$ | ${M}_{{m}_{4 , 1}}^{( 4 , 1 )} = {M}_{{m}_{4}}^{( 4 )} ⊗ {M}_{{m}_{1}}^{( 1 )}$ |
| Q₅ | Q₂ | ${U}_{5 , 2} = {U}_{5 , 2}^{( 2 )}$ | ${M}_{{m}_{5 , 2}}^{( 5 , 2 )} = {M}_{{m}_{5}}^{( 5 )} ⊗ {M}_{{m}_{2}}^{( 2 )}$ |
| Q₆ | Q₃ | ${U}_{6 , 3} = {U}_{6 , 3}^{( 2 )}$ | ${M}_{{m}_{6 , 3}}^{( 6 , 3 )} = {M}_{{m}_{6}}^{( 6 )} ⊗ {M}_{{m}_{3}}^{( 3 )}$ |
| Q₇ | Q₄, Q₁ | ${U}_{7 , 41} = ( {U}_{7 , 4}^{( 2 )} ⊗ {𝟙}_{1} ) ( {𝟙}_{7} ⊗ {U}_{4 , 1}^{( 2 )} )$ | ${M}_{{m}_{7 , 4 , 1}}^{( 7 , 4 , 1 )} = {M}_{{m}_{7}}^{( 7 )} ⊗ {M}_{{m}_{4}}^{( 4 )} ⊗ {M}_{{m}_{1}}^{( 1 )}$ |
| Q₈ | Q₅ | ${U}_{8 , 5} = {U}_{5 , 8}^{( 2 )}$ | ${M}_{{m}_{8 , 5}}^{( 8 , 5 )} = {M}_{{m}_{8}}^{( 8 )} ⊗ {M}_{{m}_{5}}^{( 5 )}$ |
| Q₉ | Q₆, Q₅ | ${U}_{9 , 65} = ( {U}_{9 , 6}^{( 2 )} ⊗ {𝟙}_{5} ) ( {𝟙}_{9} ⊗ {U}_{6 , 5}^{( 2 )} )$ | ${M}_{{m}_{9 , 6 , 5}}^{( 9 , 6 , 5 )} = {M}_{{m}_{9}}^{( 9 )} ⊗ {M}_{{m}_{6}}^{( 6 )} ⊗ {M}_{{m}_{5}}^{( 5 )}$ |
| Q₁₀ | Q₇, Q₈, Q₉ | $\begin{matrix}{U}_{10 , 987} = ( {U}_{10 , 7}^{( 2 )} ⊗ {𝟙}_{9} ⊗ {𝟙}_{8} ) ( {U}_{10 , 8}^{( 2 )} ⊗ {𝟙}_{9} ⊗ {𝟙}_{7} ) \\ ( {U}_{8 , 7}^{( 2 )} ⊗ {𝟙}_{10} ⊗ {𝟙}_{9} ) ( {U}_{9 , 8}^{( 2 )} ⊗ {𝟙}_{10} ⊗ {𝟙}_{7} )\end{matrix}$ | ${M}_{{m}_{10 , 9 , 8 , 7}}^{( 10 , 9 , 8 , 7 )} = {M}_{{m}_{10}}^{( 10 )} ⊗ {M}_{{m}_{9}}^{( 9 )} ⊗ {M}_{{m}_{8}}^{( 8 )} ⊗ {M}_{{m}_{7}}^{( 7 )}$ |

The system subset 2a comprises three starting subsystems Q₄, Q₅, Q₆, and the ancillary subset 2b comprises for each of said starting subsystem Qᵢ₊₃, i=1, 2, 3, one connected subsystem Qᵢ.

The embodiment of the quantum computing device 1 shown in FIG. 1 furthe comprises state preparation means 6 operative, by control of the controller 5, to prepare each of said qubits in a desired initial state. For example, the state preparation means 6 may be operative to prepare each of said qubits Qₙ in the pure state described by the state vector |0 [symbol] .

The quantum computing device 1 shown in FIG. 1 may be further operative to prepare the composite system of the system qubits in the system subset 2a in a desired solution state. E.g., the quantum computing device 1 may be operative to first prepare each qubit in said system subset 2a in the pure state described by the state vector |0 [symbol] , and to then apply a sequence of quantum gates by application of the quantum gate application means 3 thereby obtaining a desired solution state of the composite system described by a density operator ρ_{S}. Furthermore, the quantum computing device 1 may be operative, by control of the controller 5, to prepare each qubit in the ancillary subset 2b in the pure state described by the state vector |0 [symbol] .

Thus, by control of the controller 5, the quantum computing device 1 may prepare a system quantum state which is described by a density operator which is a tensor product of the density operator of the desired solution state of the system qubits and a density operator of the state of the ancilla qubits, all of which are in the state described by the state vector |0 [symbol] .

The quantum computing device 1 according to the second aspect of the present invention is further operative, by control of the controller 5, to implement an initial measurement step which comprises for at least one initially selected subsystem Qₙ_{₀} the realization of the n₀-th local Positive Operator Valued Measure on said initially selected subsystem Qₙ_{₀} to thereby obtain the measurement outcome mₙ_{₀}. For the embodiment shown in FIG. 1, there are three initially selected subsystems, namely the three starting qubits Q₄, Q₅ and Q₆. For each starting qubit Qᵢ₊₃, i=1, 2, 3, the realization of the respective nᵢ₊₃-th local Positive Operator Valued Measure is by implementing the respective imperfect realization of the joint unitary operation U_{i+3,i} on the joint system of the qubit Qᵢ₊₃ and the one connected subsystem Qᵢ in the ancillary subset 2b followed by a joint quantum measurement on the joint system described by the plurality of measurement operators

$${M}_{{m}_{i + 3 , i}}^{( i + 3 , i )} = {M}_{{m}_{i + 3}}^{( i + 3 )} ⊗ {M}_{{m}_{i}}^{( i )}$$

to thereby obtain a measurement outcome m_{i+3,i}=(mᵢ₊₃, mᵢ).

Furthermore, the quantum computing device 1 according to the second aspect of the present invention is operative, by control of the controller 5, to implement an iterative measurement step which comprises for at least one iteratively selected subsystem Qₙ a realization of an n-th local Positive Operator Valued Measure on said iteratively selected subsystem Qₙ by implementing, by operation of said quantum computing device 1, said potentially imperfect realization of said joint unitary operation U_{n,n}_{_{c}} followed by said joint quantum measurement described by said plurality of measurement operators

$${M}_{{m}_{n , {n}_{c}}}^{( n , {n}_{c} )}$$

on said joint system of said iteratively selected subsystem Qₙ and said at least one connected subsystem Qₙ_{_{c}}, wherein said at least one connected subsystem Qₙ_{_{c}} is in a previously determined quantum state described by a density operator ρₙ_{_{c}}, to thereby obtain a measurement outcome mₙₙ_{_{c}}, wherein for at least one iteratively selected subsystem Qₙ at least one of said connected subsystems Qₙ_{_{c}}, and preferably each of said connected subsystems Qₙ_{_{c}}, is one of said at least one initially selected subsystems Qₙ_{₀}.

For the embodiment shown in FIG. 1, the qubits Q₇ and Q₈ may be iteratively selected in a first iterative measurement step, Q₉ may be iteratively selected in a subsequent second iterative measurement step and Q₁₀ may be iteratively selected in a final, third iterative measurement step. The connected subsystems of the iteratively selected qubits, the respective joint unitary operations and joint quantum measurements are given in the table above. The state of the at least one connected qubit of each iteratively selected qubit (e.g., Q₅ and Q₆ for the iteratively selected subsystem Q₉) is a previously determined quantum state. In one example, the previously determined quantum state is a predetermined quantum state (e.g., each connected qubit is prepared in the state |0 [symbol] before the application of the joint unitary operation). In another example, the previously determined quantum state is the state of the connected subsystem(s) after the realization of the corresponding local POVM on said connected subsystem in a previous initial or iterative measurement step.

The result of the implementation of the measurement steps is a sequence of measurement outcomes m=(m_{4,1}, m_{5,2}, m_{6,3}, m_{7,41}, m_{8,5}, m_{9,65}, m_{10,987}).

For each subsystem Qₙ in the system subset 2a, the following input may be provided to the classical computer 100 for classical postprocessing (as an example, the input for the subsystem Q₇ is given in parentheses):
The measurement outcome m_{n,n}_{_{c}} (m_{7,41}) and a representation of the associated measurement operator

$${M}_{{m}_{n , {n}_{c}}}^{( n , {n}_{c} )} ( {M}_{{m}_{7 , 41}}^{( 7 , 4 , 1 )} = {M}_{{m}_{7}}^{( 7 )} ⊗ {M}_{{m}_{4}}^{( 4 )} ⊗ {M}_{{m}_{1}}^{( 1 )} ) ;$$

A representation of a quantum channel Eₙₙ_{_{c}} describing the potentially imperfect realization of said joint unitary operation

$${U}_{n , {n}_{c}} ( {U}_{7 , 41} = ( {U}_{7 , 4}^{( 2 )} ⊗ {𝟙}_{1} ) ( {𝟙}_{7} ⊗ {U}_{4 , 1}^{( 2 )} ) ) ;$$

A representation of the reduced density operator ρₙ_{_{c}}(ρ₄₁) of said at least one connected subsystem Qₙ_{_{c}};
A representation of basis operators

$${B}_{{a}_{n}}^{( n )}$$

of a local orthonormal basic of an operator space associated with a Hilbert space Hₙ of said subsystem Qₙ. In the case of qubits, the basis operators may be, e.g., the Pauli matrices and the identity.

Then, the classical computer 100 may be programmed to calculate a representation of a local effect

$${\prod }_{{m}_{n , {n}_{c}}}^{( n , {n}_{c} )} = {\sum }_{{a}_{n}} {π}_{{a}_{n}}^{( n , {n}_{c} , {m}_{n , {n}_{c}} )} {B}_{{a}_{n}}^{( n )}$$

associated with the local Positive Operator Valued Measure realized on said selected subsystem Qₙ, wherein the coefficients

$${π}_{{a}_{n}}^{( n , {n}_{c} , {m}_{n , {n}_{c}} )} = t r [ {M}_{{m}_{n , {n}_{c}}}^{( n , {n}_{c} )} {E}_{n , {n}_{c}} ( {B}_{{a}_{n}}^{( n )} ⊗ {ρ}_{{n}_{c}} ) {M}_{{m}_{n , {n}_{c}}}^{( n , n , ) †} ]$$

are given by a trace over a product of an image of a tensor product of the basis operator

$${B}_{{a}_{n}}^{( n )}$$

and the reduced density operator ρₙ_{_{c}} under the quantum channel Eₙₙ_{_{c}}, and the measurement operator

$${M}_{{m}_{{nn}_{c}}}^{( {nn}_{c} )} .$$

Thereby, one may derive the global effect

$${\prod }_{m} = {⊗}_{n = 4}^{10} {\prod }_{{m}_{n , {n}_{c}}}^{( n , {n}_{c} )}$$

applied to the solution state.

When the quantum measurement is repeated S times, i.e., the system quantum state is prepared S times, and the measurement routine of the initial and iterative measurement steps is applied to each of said prepared system quantum states, the global effect

$${\prod }_{{m}_{s}} = {⊗}_{n = 4}^{10} {\prod }_{{m}_{n , {n}_{c}}^{( s )}}^{( n , {n}_{c} )}$$

applied to the solution state in the s-th repetition may be derived as has been explained above, wherein

$${m}_{n {n}_{c}}^{( s )}$$

is the measurement outcome for the n-th qubit Qₙ in the s-th repetition. When for every qubit Qₙ in the system subset 2a the n-th local POVM is informationally complete, the quantum measurement described by the global effects Πₘ_{ₛ} is also informationally complete. Then, each observable O which is defined on the system qubits may be expressed in terms of these global effects according to O=ΣₘωₘΠₘ, and an estimator for the observable O may be obtained via the formula

$$\overline{O} = \frac{1}{S} {\sum }_{s = 1}^{S} {ω}_{{m}_{s}} .$$

The value of the estimator may be calculated by the classical computer.

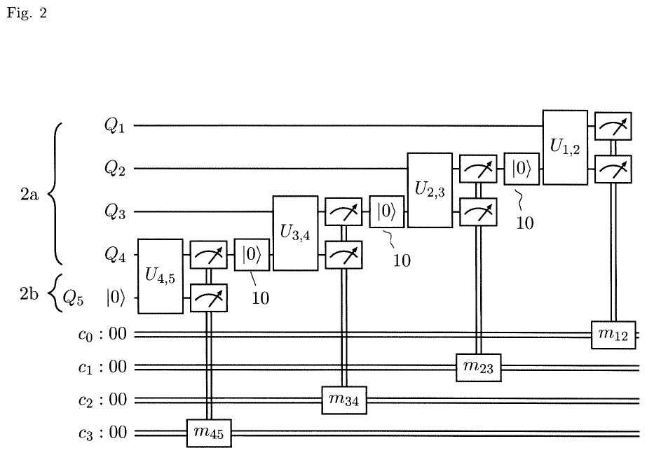

FIG. 2 depicts a quantum circuit for implementing a first embodiment of the method according to the first aspect of the present invention. The quantum circuit is applied to a composite system of 5 qubits Q₁, . . . , Q₅. The qubits are partitioned in a system subset 2a of system qubits consisting of the qubits Q₁, . . . , Q₄, and in an ancillary subset 2b of one ancillary qubit Q₅. The ancillary qubit Q₅ is prepared in the quantum state described by the state vector |0 [symbol] , and the system qubits are in a desired solution state.

As one may take from FIG. 2, the quantum circuit comprises the application of potentially imperfect two-qubit unitary operations U_{n, n+1}, n=1, . . . , 4 and local two-qubit measurements described by measurement operators

$${M}_{{m}_{n , n + 1}}^{( n , n + 1 )} = {M}_{{m}_{n}}^{( n )} ⊗ {M}_{{m}_{n + 1}}^{( n + 1 )}$$

on the joint system of qubit Qₙ and qubit Qₙ₊₁, wherein the measurement operators

$${M}_{{m}_{n}}^{( n )} , {M}_{{m}_{n + 1}}^{( n + 1 )}$$

act on the qubit Qₙ, Qₙ₊₁, respectively. The measurement operators

$${M}_{{m}_{n}}^{( n )}$$

are projective measurement operators on the quantum state |0 [symbol] and |1 [symbol] , respectively with associated measurement outcome mₙ=0 for the state |0 [symbol] and mₙ=1 for the state |1 [symbol] .

The quantum circuit shown in FIG. 2 realizes the method according to the present invention as follows:

The application of the potentially imperfect realization of the joint unitary operation U_{4,5} on the joint system of the qubit Q₅ prepared in the state described by the state vector |0 [symbol] and the system qubit Q₄ followed by the joint quantum measurement of said joint system with measurement operators

$${M}_{{m}_{4 , 5}}^{( 4 , 5 )} = \vert {m}_{4} , {m}_{5} 〉 〈 {m}_{4} , {m}_{5} \vert$$

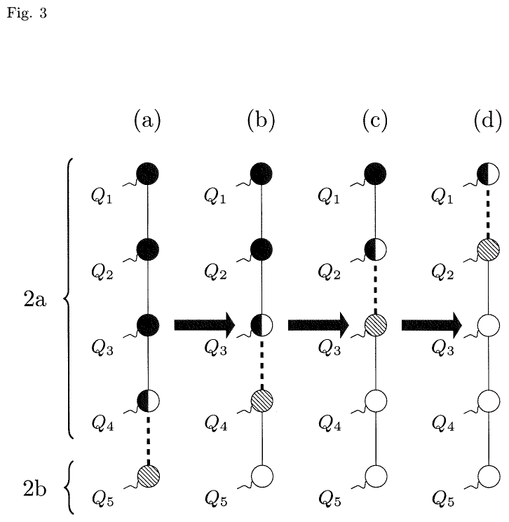

results in a measurement outcome m_{4,5}=(m₄, m₅) mᵢ∈{0,1} which is provided to a classical computer and stored in two classical bits c₃ which are initially in the state 00. I.e., c₃ is set to m₄m₅. In this way, the initial measurement step is realized for the initially selected subsystem Q₄, thereby realizing the 4-th local POVM on the subsystem Q₄. The implementation of the initial measurement step is also shown schematically in FIG. 3a.

Next, for the qubits Qᵢ, i=3, 2, 1, the iterative measurement step is iteratively applied. First, a reset operation 10 is applied to the connected qubit Qᵢ₊₁ of the iteratively selected qubit Qᵢ, so that the qubit Qin is in the quantum state described by the state vector |0 [symbol] . Then, the potentially imperfect realization of the joint unitary operation U_{i,i+1} is applied to the joint system of the qubit Qᵢ and its one connected subsystem Qᵢ₊₁ followed by the application of the joint quantum measurement described by the measurement operators

$${M}_{{m}_{i , i + 1}}^{( i , i + 1 )} = \vert {m}_{i} , {m}_{i + 1} 〉 〈 {m}_{i} , {m}_{i + 1} \vert$$

resulting in a measurement outcome m_{i i+1}=(mᵢ,mᵢ₊₁). This measurement outcome is provided to the classical computer and stored in two classical bits Cᵢ₋₁ which are initialized in the state 00. The implementation of the iterative measurement steps is also shown schematically in FIGS. 3 (b)-(d).

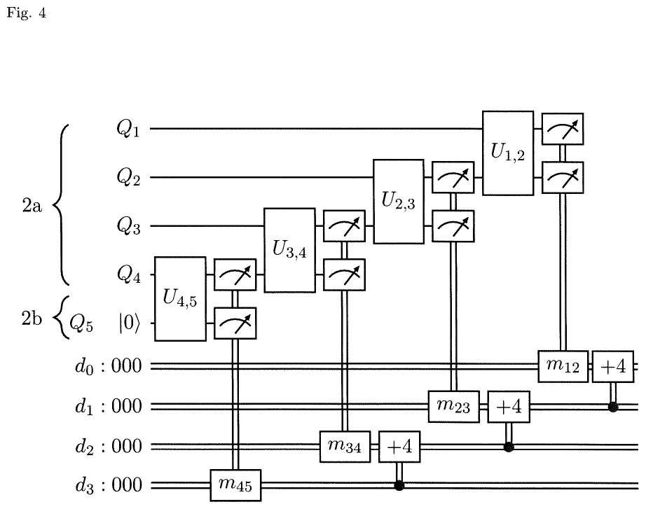

FIG. 4 depicts a quantum circuit for implementing a second embodiment of the method according to the first aspect of the present invention. As one may take from the comparison of the quantum circuits shown in FIG. 2 and FIG. 4, the quantum circuit of FIG. 4 differs from the quantum circuit of FIG. 2 in that no reset operation is applied in the iterative measurement steps and it further differs in the storing of the measurement outcome m_{i,i+1}. More precisely, the measurement outcome m_{i,i+1} is stored in three classical bits dᵢ₋₁ and is stored as the value m_{i,i+1}+4 if the measurement outcome for the system Qᵢ₊₁ in the preceding measurement step was mᵢ₊₁=1, and it is stored as the measurement outcome m_{i,i+1} if the measurement outcome for the subsystem Qᵢ₊₁ in the preceding measurement step was mᵢ₊₁=0.

For the embodiment shown in FIG. 4 it is assumed that the joint unitary operations are realized perfectly. Then, the POVM with effects

$${\prod }_{{m}_{4 , 5}}^{( 0 )} ⊗ {\prod }_{{m}_{3 , 4}}^{( {m}_{4 , 5} )} ⊗ {\prod }_{{m}_{2 , 3}}^{( {m}_{3 , 4} )} ⊗ {\prod }_{{m}_{1 , 2}}^{( {m}_{2 , 3} )}$$

is realized, wherein

$${\prod }_{{m}_{i , i + 1}}^{( {m}_{i + 1 , i + 2} )} = {\sum }_{{a}_{i}} {π}_{{a}_{i}}^{( {m}_{i , i + 1} , {m}_{i + 1 , i + 2} )} {B}_{{a}_{i}}^{( i )}$$

with coefficients

$${π}_{{a}_{i}}^{( {m}_{i , i + 1} , {m}_{i + 1 , i + 2} )} = tr [ {U}_{i , i + 1} ( {B}_{{a}_{i}}^{( i )} ⊗ \vert {m}_{i + 1} 〉 〈 {m}_{i + 1} \vert ) {U}_{i , i + 1}^{†} \vert {m}_{i} , {m}_{i + 1} 〉 〈 {m}_{i} , {m}_{i + 1} \vert ] and {B}_{{a}_{i}}^{( i )}$$

are basis operators of a local orthonormal basis of an operator space associated with a Hilbert space Hᵢ of the qubit Qᵢ.

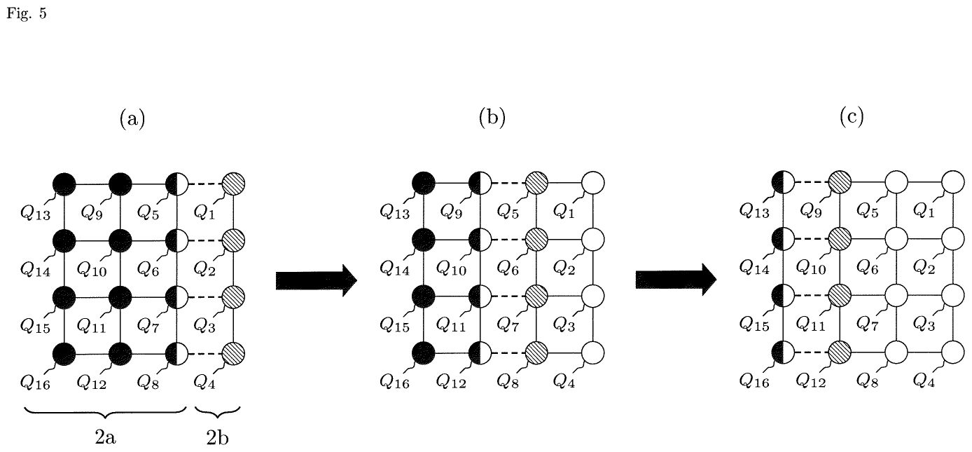

FIG. 5 schematically represents the iterative selection of subsystems of a composite system of an embodiment of a quantum computing device according to the present invention. The composite system shown in FIG. 5 comprises 16 subsystems Qₙ with a square lattice connectivity. I.e., the quantum computing device is operative to implement a joint unitary operation and a joint quantum measurement on a joint system of two neighbouring subsystems Qₙ and Q_{n′} on the lattice (e.g., Q₆ and Q₁₀ or Q₆ and Q₅). The subsystems are divided in a set of system subsystems Q₅, . . . , Q₁₆ with starting subsystems Q₅, . . . , Q₈ and a set of ancillary subsystems Q₁, . . . , Q₄.

The embodiment of the method shown in FIG. 5 starts with an initial measurement step wherein for each of the starting subsystems Qᵢ₊₄, i=1, . . . , 4, an (i+4)th local POVM is realized on said starting subsystem by implementing the joint local unitary operation U_{i+4,i} followed by a joint quantum measurement on the joint system of the starting subsystem Qᵢ₊₄ and its one connected subsystem Qᵢ. Next, two iterative measurement steps are implemented. In the first iterative measurement step, the (i+8)-th local POVM is implemented on the iteratively selected subsystems Qᵢ₊₈, i=1, . . . 4 by implementing the joint local unitary operation U_{i+8,i+4} followed by a joint quantum measurement on the joint system of the iteratively selected subsystem Qᵢ₊₈ and its one connected subsystem Qᵢ₊₄. Then, in the last iterative measurement step, the (i+12)-th local POVM is implemented on the iteratively selected subsystems Qᵢ₊₁₂, i=1, . . . 4 by implementing the joint local unitary operation U_{i+12,i+8} followed by a joint quantum measurement on the joint system of the iteratively selected subsystem Qᵢ₊₁₂ and its one connected subsystem Qᵢ₊₈. In this way local POVMs may be efficiently implemented on the twelve subsystems Qᵢ, i=5, . . . , 16 in three time steps using only four ancillary qubits.

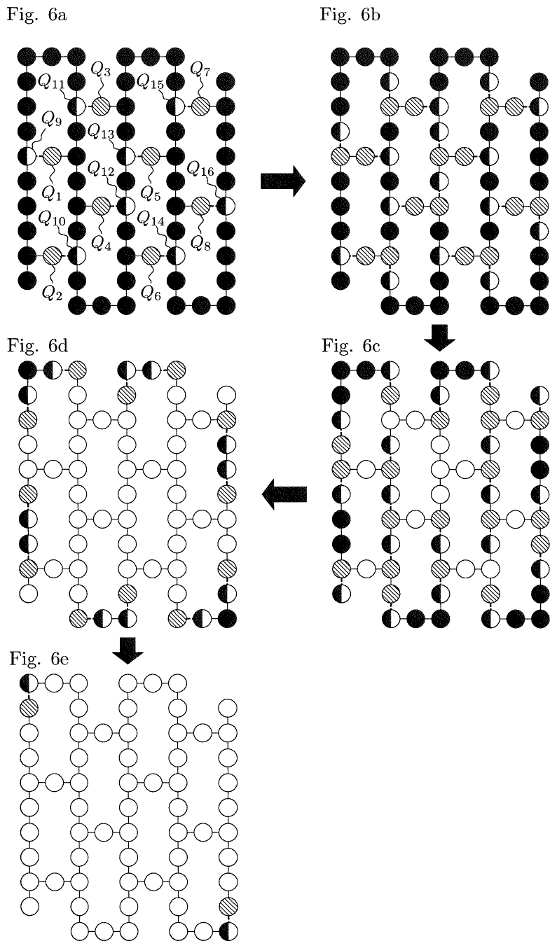

FIGS. 6a-6e schematically represent another example of the method according to the first aspect of the present invention with an iterative selection of subsystems Qₙ of a composite system of a quantum computing device as indicated in the figures. The composite system consists of 65 subsystems Qₙ illustrated as circles in FIGS. 6a-6e with a hexagonal connectivity. I.e., for subsystems Qₙ, Q_{n′} connected by a line, the quantum computing device is operative to implement a potentially imperfect realization of a joint unitary operation followed by a joint quantum measurement on the joint system of the subsystem Qₙ and its connected subsystem Q_{n′}, as explained above. The above method may be realized, e.g., with the IBM Quantum 65-qubit ibmq_manhattan device (see, e.g., G. Mooney et. al., Advanced Quantum Technologies Vol 4, Issue 10).

The system is divided in 8 ancillary subsystems (qubits) Q1, . . . , Q8 and 57 system qubits Q₉-Q₆₅ (reference signs are omitted for sake of clarity) as indicated in FIG. 6a. In FIGS. 6a-6e, the initially or iteratively selected subsystems are indicated as hatched circles, and the respective connected subsystems are indicated by a half-filled circle connected with the selected subsystem by a dashed line.

According to the method of FIGS. 6a-6e, the method starts with the initial measurement step wherein a local POVM is implemented on the system qubits (starting qubits) Q₉, . . . . Q₁₆ by implementing the potentially imperfect realization of the joint unitary operation followed by the joint quantum measurement on the joint system of the initially selected qubits Qᵢ₊₈, i=1 . . . ,8, and the respective connected subsystem Qᵢ. In this way, an (i+8)-th local POVM is realized on the qubit Q_{i+8.}

FIGS. 6b-6e illustrate the subsequent four iterative measurement steps. White circles indicate qubits for which the local POVM has been realized in a previous measurement step or ancillary qubits not used in the current iterative measurement step and which are not connected subsystems in the present iterative measurement step. 16 local POVMs are simultaneously realized in the first iterative measurement step shown in FIG. 6b, 19 local POVMs are simultaneously realized in the second iterative measurement step shown in FIG. 6c, 12 local POVMs are simultaneously realized in the third iterative measurement step shown in FIG. 6d and 2 local POVMs are simultaneously realized in the fourth iterative measurement step shown in FIG. 6e. In this way, 57 local POVMs are implemented on 57 qubits in a very time- and resource efficient manner in only five time steps.

1. A method for implementing a quantum measurement on a system quantum state of a composite system of a quantum computing device, said composite system comprising a plurality of quantum mechanical subsystems Qₙ, n=1, . . . , N, N≥2, said quantum mechanical subsystems being preferably qubits, and said quantum computing device having a connectivity and operativity that allows to implement for each of said subsystems Qₙ a potentially imperfect realization of a joint unitary operation U_{n,n}_{_{c}} and a joint quantum measurement on a joint system of said subsystem Qₙ and at least one connected subsystem Qₙ_{_{c}} of said plurality of subsystems, said realization of said joint quantum measurement being described by a plurality of measurement operators M_{Mn,nc}^{N,N,c}, each measurement operator
$${M}_{{m}_{n , {n}_{c}}}^{( n , {n}_{c} )}$$
being associated with a measurement outcome m_{n,n}_{_{c}},
wherein said method comprises:
an initial measurement step which comprises for at least one initially selected subsystem Qₙ_{₀} a realization of an n₀-th local Positive Operator Valued Measure on said initially selected subsystem Qₙ_{₀} to thereby obtain a measurement outcome mₙ_{₀};
an iterative measurement step which comprises for at least one iteratively selected subsystem Qₙ a realization of an n-th local Positive Operator Valued Measure on said iteratively selected subsystem Qₙ by implementing, by operation of said quantum computing device, said potentially imperfect realization of said joint unitary operation U_{n,n}_{_{c}} followed by said joint quantum measurement described by said plurality of measurement operators
$${M}_{{m}_{n , {n}_{c}}}^{( n , {n}_{c} )}$$
on said joint system of said iteratively selected subsystem Qₙ and said at least one connected subsystem Qₙ_{_{c}}, wherein said at least one connected subsystem Qₙ_{_{c}} is in a previously determined quantum state described by a density operator on ρₙ_{_{c}}, to thereby obtain a measurement outcome m_{n,n}_{_{c}},
wherein for at least one iteratively selected subsystem Qₙ at least one of said connected subsystems Qₙ_{_{c}}, and each of said connected subsystems Qₙ_{_{c}}, is one of said at least one initially selected subsystems Qₙ_{ₒ}.

2. The method of claim 1, wherein said iterative measurement step is iterated, and wherein the connectivity of the quantum computing device and the iteration is such that for at least one of the iteratively selected subsystems Qₙ, and for each iteratively selected subsystem Qₙ, the n_{c}-th local Positive Operator Valued Measure has been previously realized on at least one, and on each of said connected subsystems Qₙ_{_{c}} of said at least one iteratively selected subsystem Qₙ in a previous initial or iterative measurement step.

3. The method of claim 2, wherein said iteration is terminated when for each subsystem Qₙ the respective n-th local Positive Operator Valued Measure has been realized.

4. The method of claim 3, wherein said connectivity and said operativity of said quantum computing device is such that for at least one subsystem Qₙ, and for each subsystem, the potentially imperfect realization of said joint unitary operation U_{n,n}_{_{c}} on said joint system is by an application of a sequence of local unitary operations, wherein each local unitary operation is acting on at most two subsystems of said joint system.

5. The method of claim 4, wherein said plurality of subsystems is partitioned in a system subset and an ancillary subset which is a complement of said system subset such that said ancillary subset comprises the at least one connected subsystem Qₙ_{_{sc}} of at least one starting subsystem Qₙ_{ₛ} in said system subset, wherein for each starting subsystem Qₙ_{ₛ} the previously determined quantum state of said at least one connected subsystem Qₙ_{_{sc}} is a predetermined quantum state described by the density operator ρₙ_{_{sc}} and wherein said connectivity and said operativity of said quantum computing device further allows to prepare said system quantum state by preparing the plurality of subsystems in said system subset in a desired solution state, by quantum gate application, and by preparing for each starting subsystem Qₙ_{ₛ} the at least one connected subsystem Qₙ_{_{sc}} of said ancillary subset in the predetermined quantum state described by the density operator ρₙ_{_{sc}}, said method further comprising:
preparing said system quantum state by operation of said quantum computing device;
and wherein the at least one initially selected subsystem Qₙ_{₀} comprises said at least one starting subsystem Qₙ_{ₛ}, and wherein for each of said starting subsystems Qₙ_{ₛ} the realization of the nₛ-th local Positive Operator Valued Measure in the initial measurement step is by implementing, by operation of said quantum computing device, said potentially imperfect realization of said joint unitary operation Uₙ_{ₛ}_{,n}_{_{sc}} followed by said joint quantum measurement described by said plurality of measurement operators
$${M}_{{m}_{{n}_{s} , {n}_{sc}}}^{( {n}_{s} , {n}_{sc} )}$$
on said joint system of said starting subsystem Qₙ_{ₛ} and said at least one connected subsystem Qₙ_{_{sc}} which is in the previously determined quantum state described by the density operator ρₙ_{_{sc}}, to thereby obtain a measurement outcome mₙ_{ₛ}_{,n}_{_{sc}}.

6. The method of claim 5, wherein said iteration is terminated when for each subsystem Qₙ in said system subset the local Positive Operator Valued Measure has been realized.

7. The method of claim 6, wherein at least one iterative measurement step comprises selecting the iteratively selected subsystems Qₙ on the basis of the measurement outcome of a preceding initial or iterative measurement step.

8. The method of claim 7, wherein for at least one iteratively selected subsystem Qₙ the previously determined quantum state of said at least one connected subsystem Qₙ_{_{c}} is a predetermined quantum state described by the predetermined density operator on ρₙ_{_{c}}, and said method further comprises preparing the at least one connected subsystem Qₙ_{_{c}} in said predetermined quantum state before the realization of the n-th local Positive Operator Valued Measure on said at least one iteratively selected subsystem Qₙ in the iterative measurement step.

9. The method of claim 8, wherein said predetermined quantum state is a pure quantum state.

10. The method of claim 9, wherein said quantum computing device is further operative to implement for at least one of said subsystems Qₙ a plurality of P potentially imperfect realizations of joint unitary operations
$${U}_{n , {n}_{c}}^{( p )} , p = 1 , … , P ,$$
and a plurality of R joint quantum measurements on the joint system of said subsystem Qₙ and the at least one connected subsystem Qₙ_{_{c}}, said realization of said r-th joint quantum measurement, r=1, . . . , R, being described by a plurality of measurement operators
$${M}_{{m}_{n , {n}_{c}}}^{( r , n , {n}_{c} )} ,$$
measurement operator
$${M}_{{m}_{n , {n}_{c}}}^{( r , nn {,}_{c} )}$$
being associated with a measurement outcome m_{N,N,c}^{(r)}, and wherein said realization of said n-th local Positive Operator Valued Measure on said subsystem Qₙ comprises selecting one of said joint unitary operations
$${U}_{n , {n}_{c}}^{( p )}$$
of said plurality and selecting one of said joint quantum measurements of said plurality described by the measurement operators
$${M}_{{m}_{n , {n}_{c}}}^{( r , n , {n}_{c} )}$$
and implementing, by operation of said quantum computing device, said potentially imperfect realization of said selected joint unitary operation
$${U}_{n , {n}_{c}}^{( p )}$$
followed by said selected joint quantum measurement described by said plurality of measurement operators
$${M}_{{m}_{n , {n}_{c}}}^{( r , n , {n}_{c} )}$$
on said joint system of said iteratively selected subsystem Qₙ and said at least one connected subsystem Qₙ_{_{c}}.

11. The method of claim 10, wherein said selection is on the basis of the measurement outcome of a preceding initial or iterative measurement step and/or said selection is a random selection.

12. The method of claim 11, wherein for at least one iteratively selected subsystem Qₙ the n_{c}-th local Positive Operator Valued Measure has been realized on the at least one connected subsystem Qₙ_{_{c}} with measurement outcome mₙ_{_{c}} in the initial measurement step or in one of the previous measurement steps, the previously determined quantum state of the at least one connected subsystem Qₙ_{_{c}} is the state of said at least one connected subsystem Qₙ_{_{c}} after the realization of the n_{c}-th local Positive Operator Valued Measure on said connected subsystem Qₙ_{_{c}}, and said method further comprises inferring the reduced density operator ρₙ_{_{c}} of said at least one connected subsystem Qₙ_{_{c}} on the basis of said measurement outcome mₙ_{_{c}}.

13. The method of claim 12, wherein for at least one iteratively selected second subsystem Qₙ_{₂} of a second iterative measurement step the at least one connected subsystem Qₙ_{_{1,2c}} is also the at least one connected subsystem Qₙ_{_{1,2c}} of a previously selected first subsystem Qₙ_{₁} of a previous iterative measurement step, the previously determined quantum state of said at least one connected subsystem Qₙ_{_{1,2c}} in said second iterative measurement step being the state of said at least one connected subsystem Qₙ_{_{1,2c after the realization of said n}}₁-th local Positive Operator Valued Measure on said first subsystem Qₙ_{₁} in said previous iterative measurement step, and said method further comprises inferring the reduced density operator of the at least one connected subsystem Qₙ_{_{1,2c}} in the second iterative measurement step on the basis of said measurement outcome mₙ_{₁}ₙ_{_{1,2c}} which is obtained when realizing the n₁-th local Positive Operator Valued Measure on said first subsystem Qₙ_{₁} in said previous measurement step.

14. The method of claim 13, wherein for at least one subsystem Qₙ the plurality of measurement operators
$${M}_{{m}_{n , {n}_{c}}}^{( n , {n}_{c} )}$$
describe a potentially imperfect realization of a projective measurement, and said measurement operators
$${M}_{{m}_{n , {n}_{c}}}^{( n , {n}_{c} )}$$
describe a realization of a projective measurement.

15. The method of claim 14, wherein for at least one subsystem Qₙ the joint quantum measurement is a local quantum measurement with respect to the subsystem Qₙ and the at least one connected subsystem Qₙ_{_{c}} of said joint system so that each measurement operator
$${M}_{{m}_{n , {n}_{c}}}^{( n , {n}_{c} )}$$
of said plurality is a tensor product
$${M}_{{m}_{n , {n}_{c}}}^{( n , {n}_{c} )} = {M}_{{m}_{n}}^{( n )} ⊗ {M}_{{m}_{{n}_{c}}}^{( {n}_{c} )} , wherein {M}_{{m}_{n}}^{( n )}$$
is a measurement operator of a first quantum measurement defined on the subsystem Qₙ with associated measurement outcome mₙ and
$${M}_{{m}_{{n}_{c}}}^{( {n}_{c} )}$$
is a measurement operator of a second quantum measurement defined on and the at least one connected subsystem Qₙ_{_{c}} with associated measurement outcome mₙ_{_{c}}, and the quantum measurement is local with respect to each subsystem of said joint system, i.e., the measurement operators
$${M}_{{m}_{n , {n}_{c}}}^{( n , {n}_{c} )}$$
are tensor products of measurement operators of quantum measurements on each subsystem of said joint system.

16. The method of claim 15, wherein for at least one subsystem Qₙ said realization of said unitary operation U_{n,n}_{_{c}} is a perfect realization of said unitary operation Uₙₙ_{_{c}}.

17. The method of claim 16, wherein said method further comprises for at least one initially or iteratively selected subsystem Qₙ:
c. providing the following input to a classical computer:
the measurement outcome m_{n,n}_{_{c}} and a representation of the associated measurement operator
$${M}_{{m}_{n , {n}_{c}}}^{( n , {n}_{c} )} ;$$
a representation of a quantum channel E_{n,n}_{_{c}} describing the potentially imperfect realization of said joint unitary operation U_{n,n}_{_{c}};
a representation of the reduced density operator ρₙ_{_{c}} of said at least one connected subsystem Qₙ_{_{c}};
a representation of basis operators
$${B}_{{a}_{n}}^{( n )}$$
of a local orthonormal basis of an operator space associated with a Hilbert space Hₙ of said subsystem Qₙ;
d. calculating, by the classical computer, a representation of a local effect
$${\prod }_{{m}_{n , {n}_{c}}}^{( n , {n}_{c} )} = {\sum }_{{a}_{n}} {π}_{{a}_{n}}^{( n , {n}_{c} , {m}_{n , {n}_{c}} )} {B}_{{a}_{n}}^{( n )}$$
associated with the local Positive Operator Valued Measure realized on said selected subsystem Qₙ, wherein the coefficients
$${π}_{{a}_{n}}^{( n , {n}_{c} , {m}_{n , {n}_{c}} )} = tr [ {M}_{{m}_{n , {n}_{c}}}^{( n , {n}_{c} )} {E}_{n , {n}_{c}} ( {B}_{{a}_{n}}^{( n )} ⊗ {ρ}_{{n}_{c}} ) {M}_{{m}_{n , {n}_{c}}}^{( n , {n}_{c} ) †} ]$$
are given by a trace over a product of an image of a tensor product of the basis operator
$${B}_{{a}_{n}}^{( n )}$$
and the reduced density operator ρₙ_{_{c}} under the quantum channel E_{n,n}_{_{c}}, and the measurement operator
$${M}_{{m}_{n , {n}_{c}}}^{( n , {n}_{c} )}$$
and its hermitian conjugate.

18. A quantum computing device said quantum computing device comprising a composite system comprising a plurality of quantum mechanical subsystems Qₙ, n=1, . . . , N, N≥2, said quantum mechanical subsystems being qubits, and said quantum computing device having a connectivity and operativity that allows to implement for each of said subsystems Qₙ a potentially imperfect realization of a joint unitary operation U_{n,n}_{_{c}} and a joint quantum measurement on a joint system of said subsystem Qₙ and at least one connected subsystem Qₙ_{_{c}} of said plurality of subsystems, said realization of said joint quantum measurement being described by a plurality of measurement operators
$${M}_{{m}_{n , {n}_{c}}}^{( n , {n}_{c} )} ,$$
being associated with a measurement each measurement operator
$${M}_{{m}_{n , {n}_{c}}}^{( n , {n}_{c} )}$$
bring associated with a measurement outcome m_{n,n}_{_{c}},
said quantum computing device further comprising means for realizing an n₀-th local Positive Operator Valued Measure on at least one initially selected subsystem Qₙ_{₀} to thereby obtain a measurement outcome mₙ_{₀}, and a controller,
wherein said quantum computing device is operative, by control of the controller, to implement an initial measurement step which comprises for at least one initially selected subsystem Qₙ_{₀} the realization of the n₀-th local Positive Operator Valued Measure on said initially selected subsystem Qₙ_{₀} to thereby obtain the measurement outcome mₙ_{₀} and to implement an iterative measurement step which comprises for at least one iteratively selected subsystem Qₙ a realization of an n-th local Positive Operator Valued Measure on said iteratively selected subsystem Qₙ by implementing, by operation of said quantum computing device, said potentially imperfect realization of said joint unitary operation U_{n,n}_{_{c}} followed by said joint quantum measurement described by said plurality of measurement operators
$${M}_{{m}_{n , {n}_{c}}}^{( n , {n}_{c} )}$$
on said joint system of said iteratively selected subsystem Qₙ and said at least one connected subsystem Qₙ_{_{c}}, wherein said at least one connected subsystem Qₙ_{_{c}} is in a previously determined quantum state described by a density operator ρₙ_{_{c}}, to thereby obtain a measurement outcome m_{n,n}_{_{c}},
wherein for at least one iteratively selected subsystem Qₙ at least one of said connected subsystems Qₙ_{_{c}}, and each of said connected subsystems Qₙ_{_{c}}, is one of said at least one initially selected subsystems Qₙ_{₀}.
